(19) United States
(12) Patent Application Publication
(10) Pub. No.: US 2008/0223047 A1
(43) Pub. Date: Sep. 18, 2008

(54) Xplogen TM: a system, method, and apparatus for generating energy from a series of dissociation reactions

(76) Inventor: Troy Lee Oliver, Madisonville, KY (US)

Correspondence Address: Troy Oliver, 330 Littlefoot Lane, Madisonville, KY, 42431, US

(21) Appl. No.: 11/975,493

(22) Filed: Oct. 19, 2007

Related U.S. Application Data
(60) Provisional application No. 60/852,641, filed on Oct. 19, 2006.

(51) Int. Cl. F02C 3/00; F02C 3/20

(52) U.S. Cl. 60/784; 60/783; 60/39.12; 60/39.19; 60/39.23

(57) ABSTRACT

Methods, systems, and apparatus for generating energy from a process-contained series of thermobaric reactions and/or explosion cycles are provided. The Xplogen™ energy generating system includes several embodiments for stimulating the heat and pressure release episodes, which are directed by the process system toward the task of dissociating a target substance being subjected to the hyper-stimulated pulse of energy. The target substance is thermolyzed by the pulse energy episode and the resulting dissociated gases are either quenched and captured or they are consumed in a direct thermal conversion process and are thus translated into steam pressure, and/or torque, thrust, motive force, and/or super-heat impulses. The methods and systems of the present invention include a comprehensive arrangement of process configurations and components as well as a means of operation.

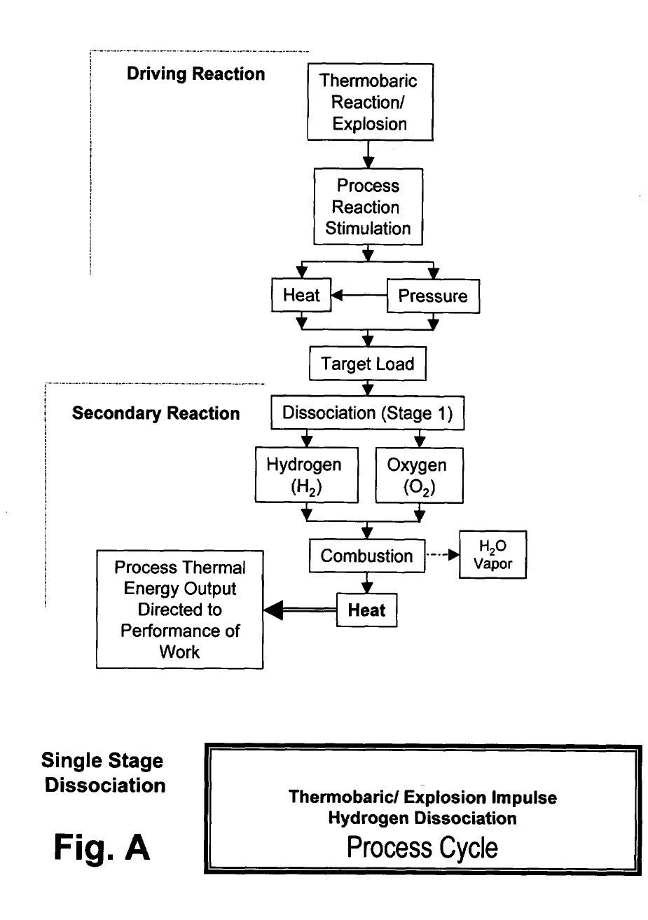

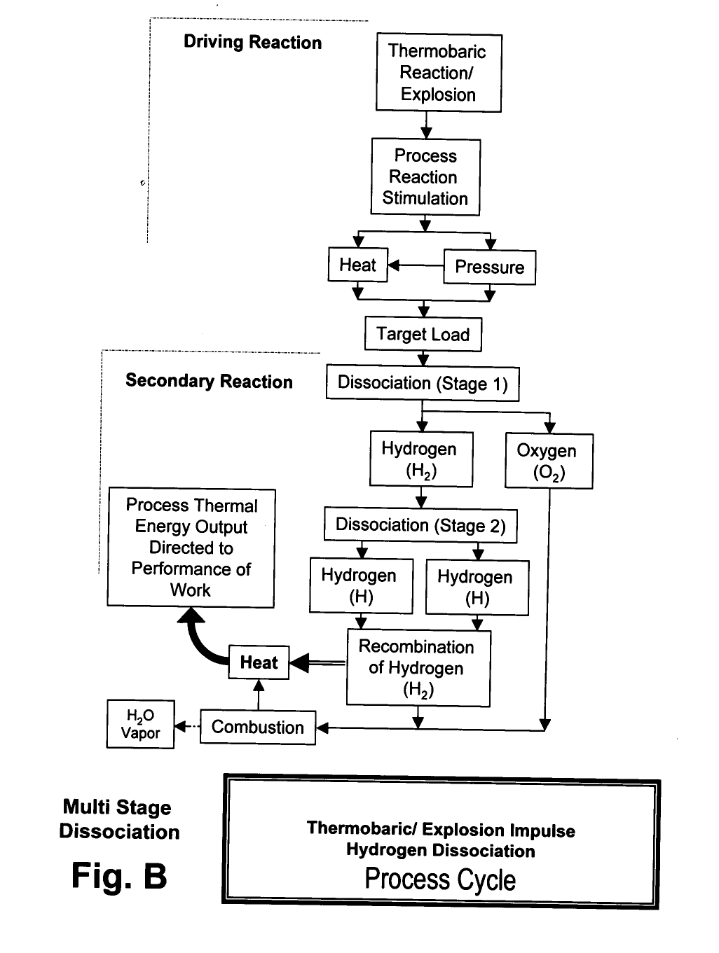

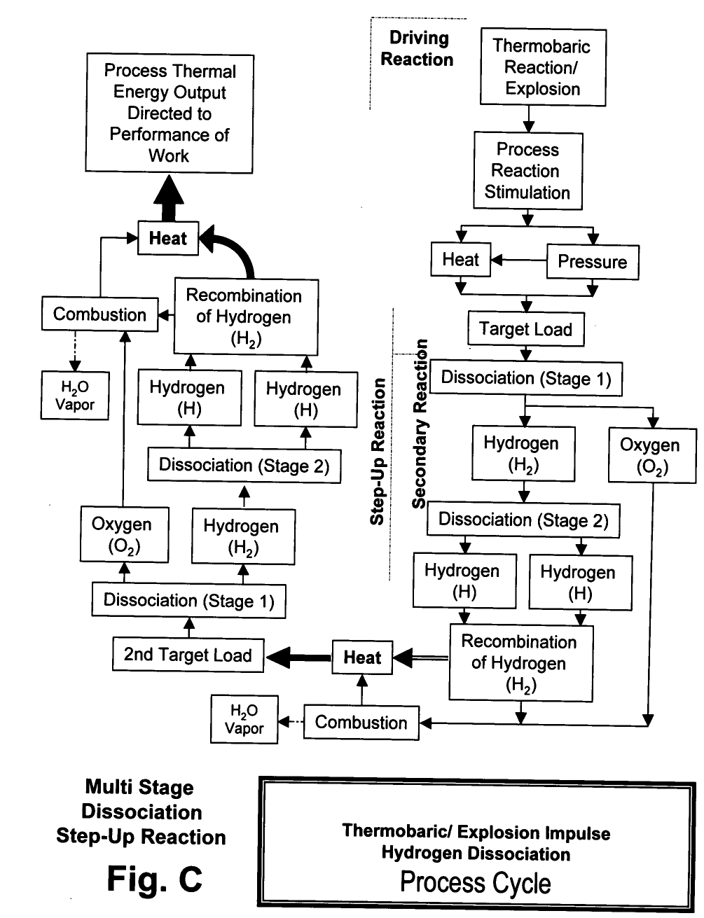

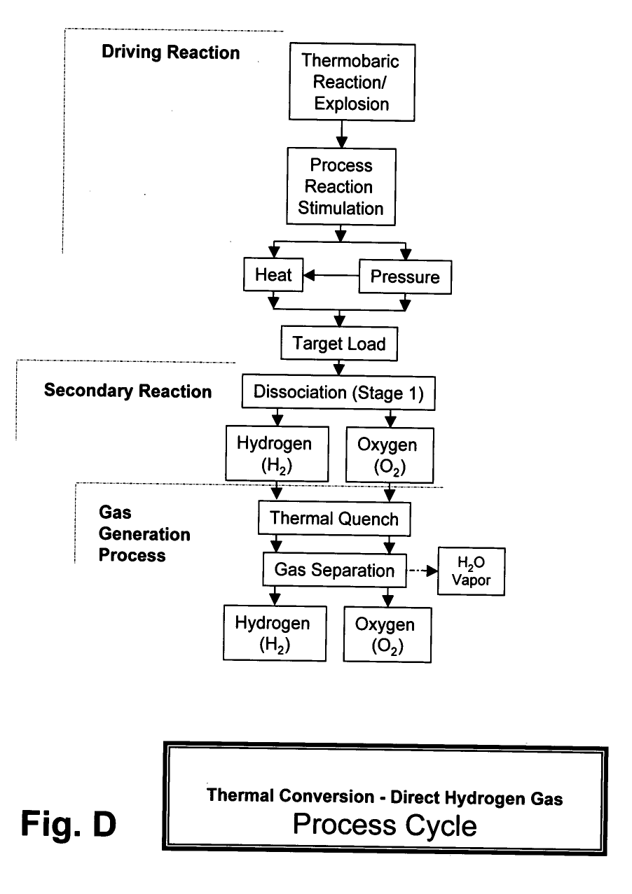

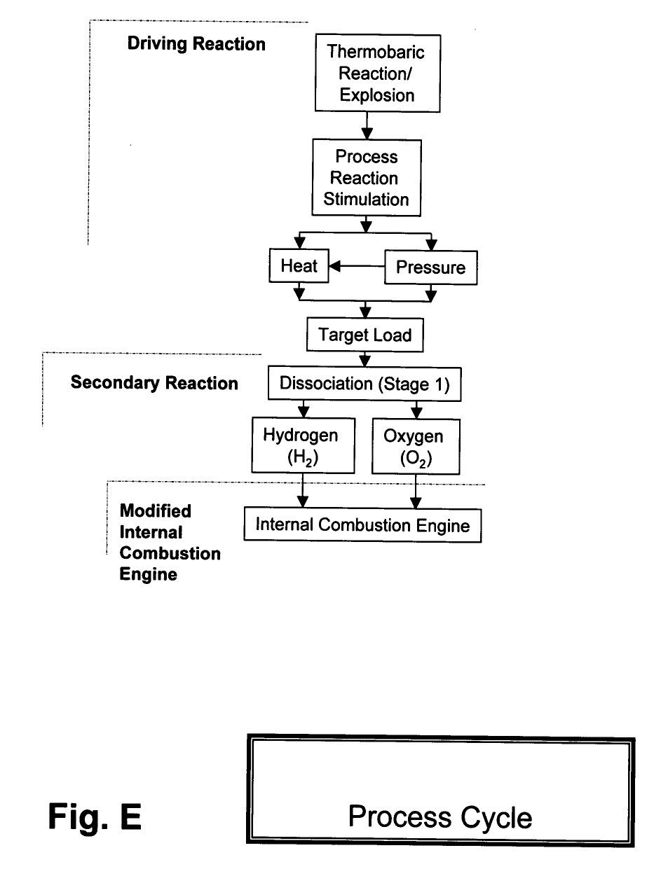

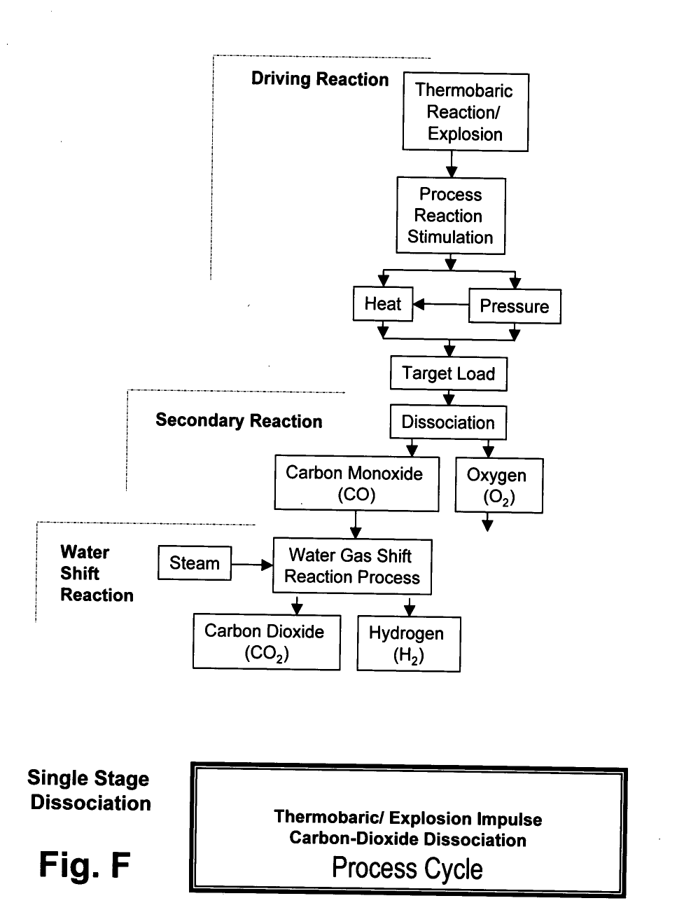

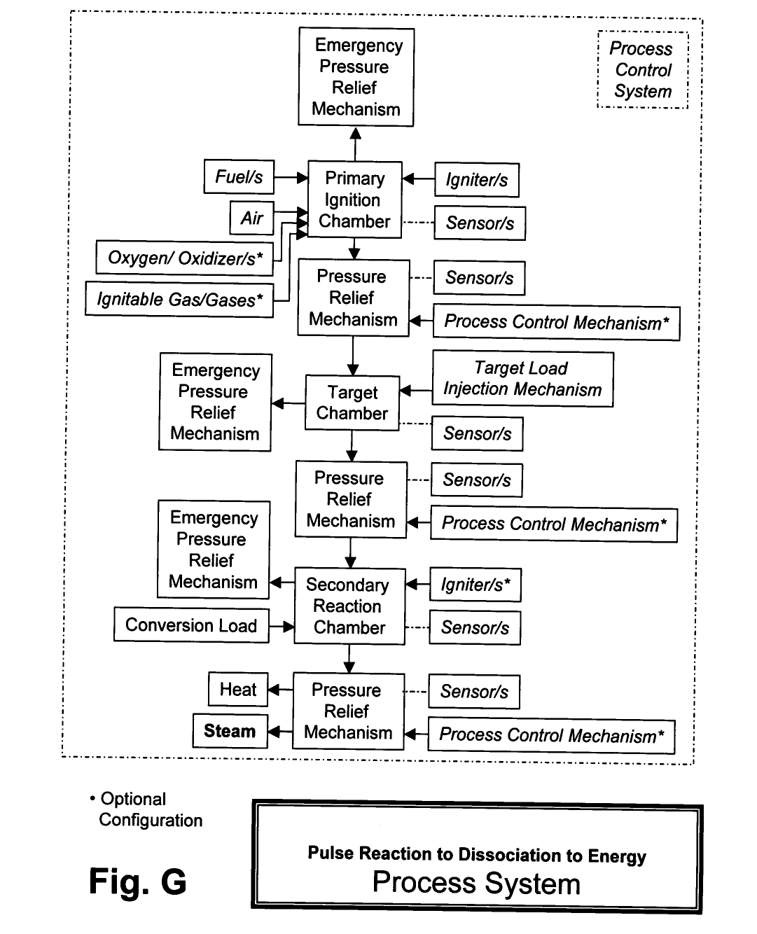

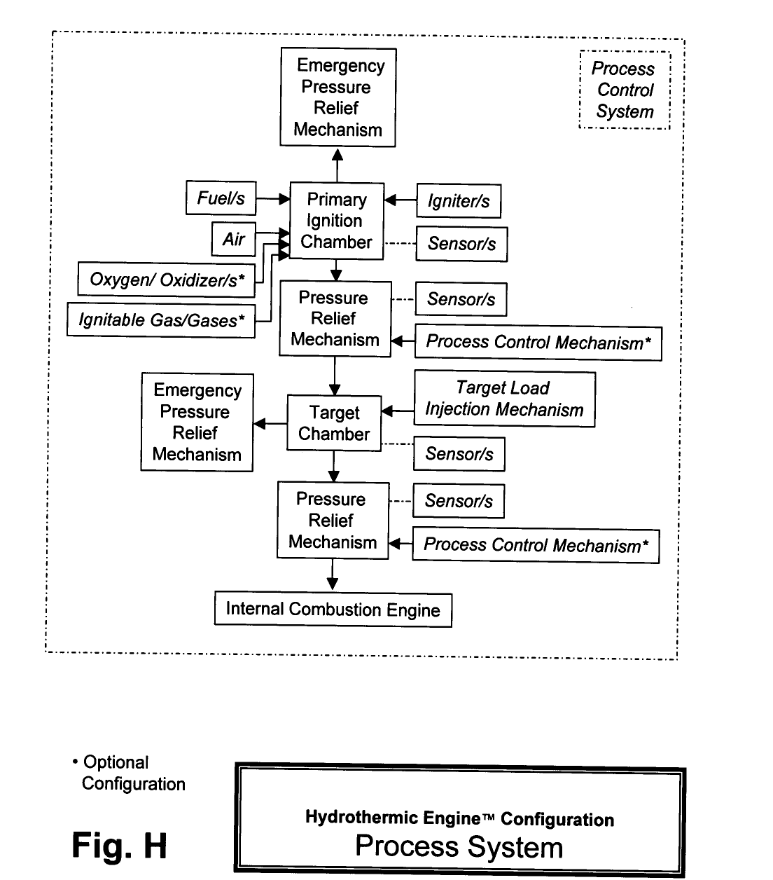

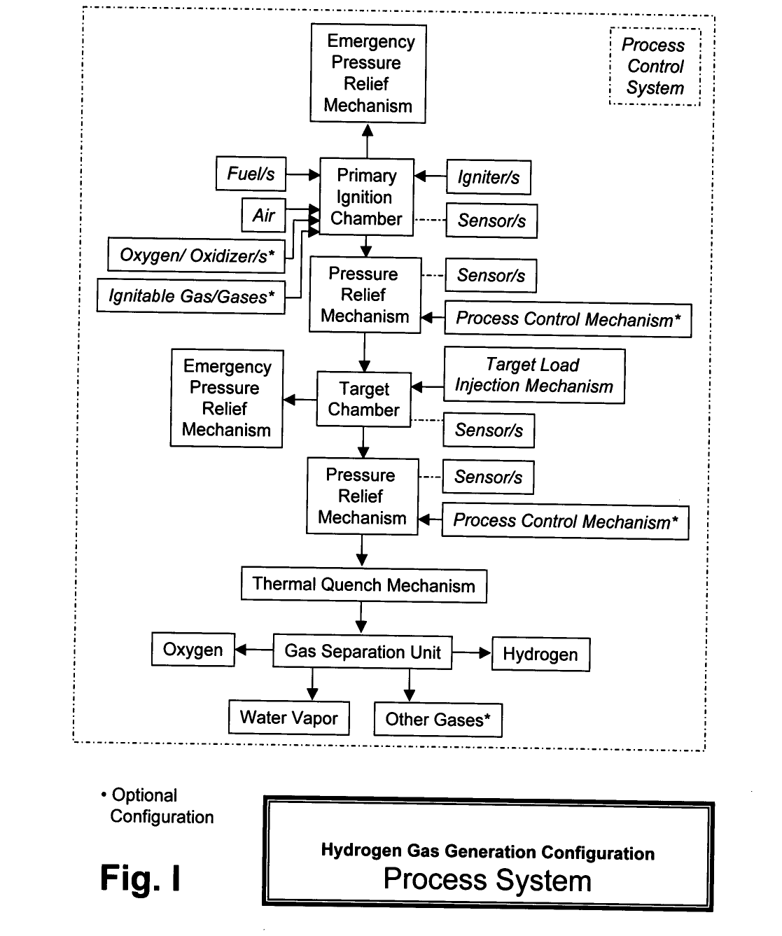

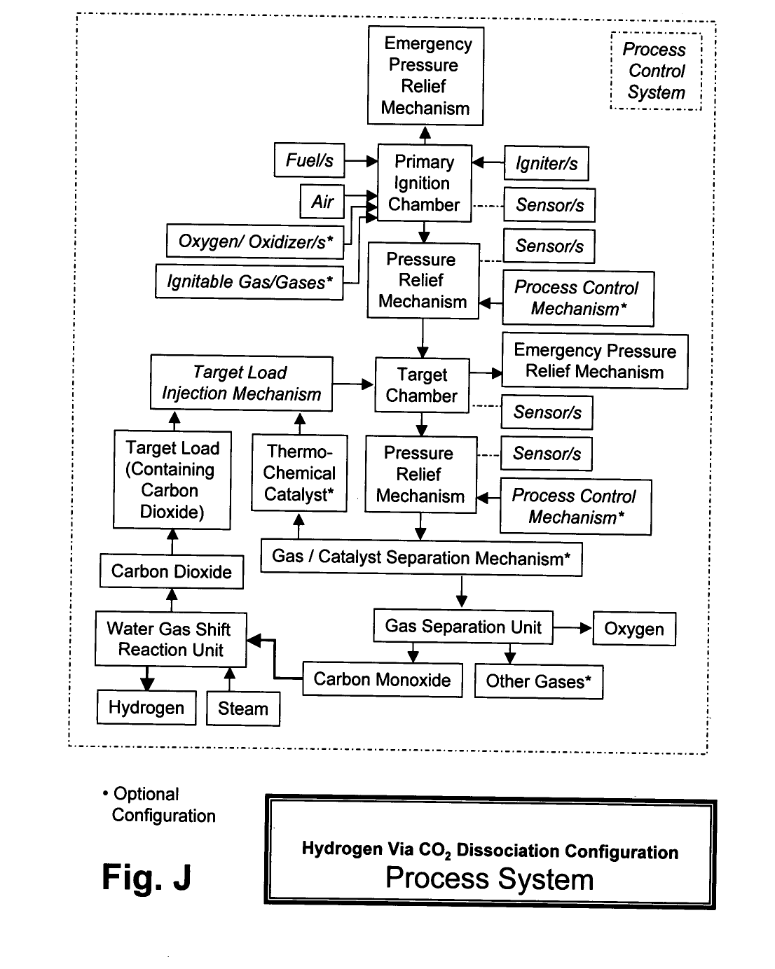

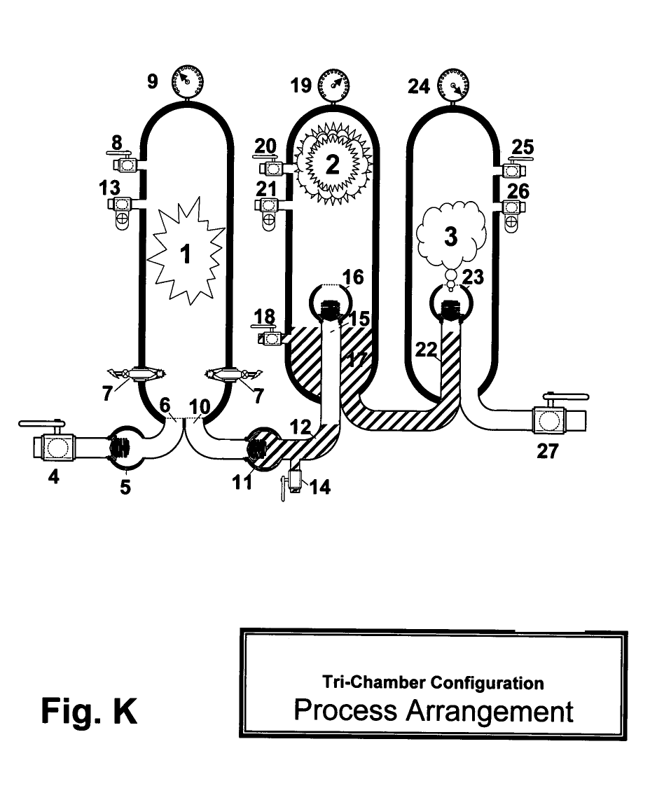

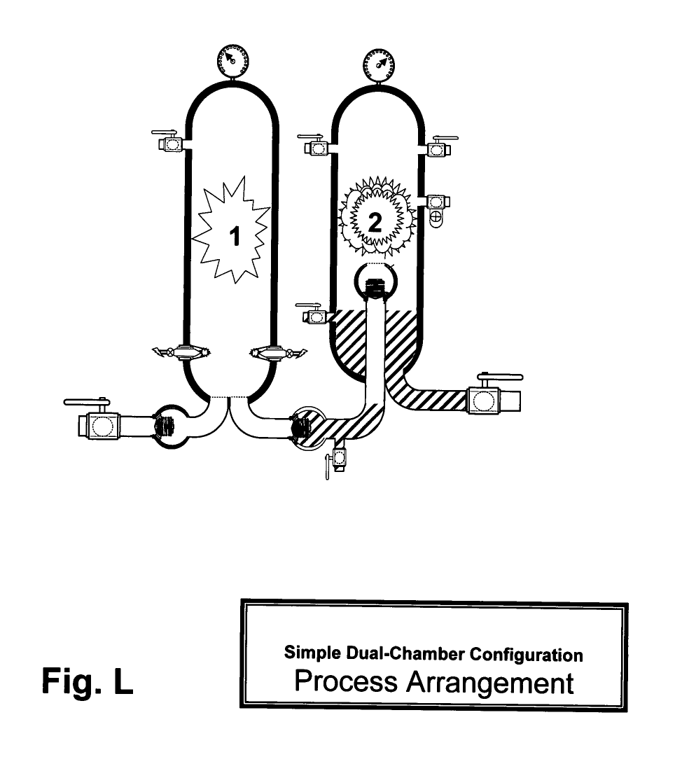

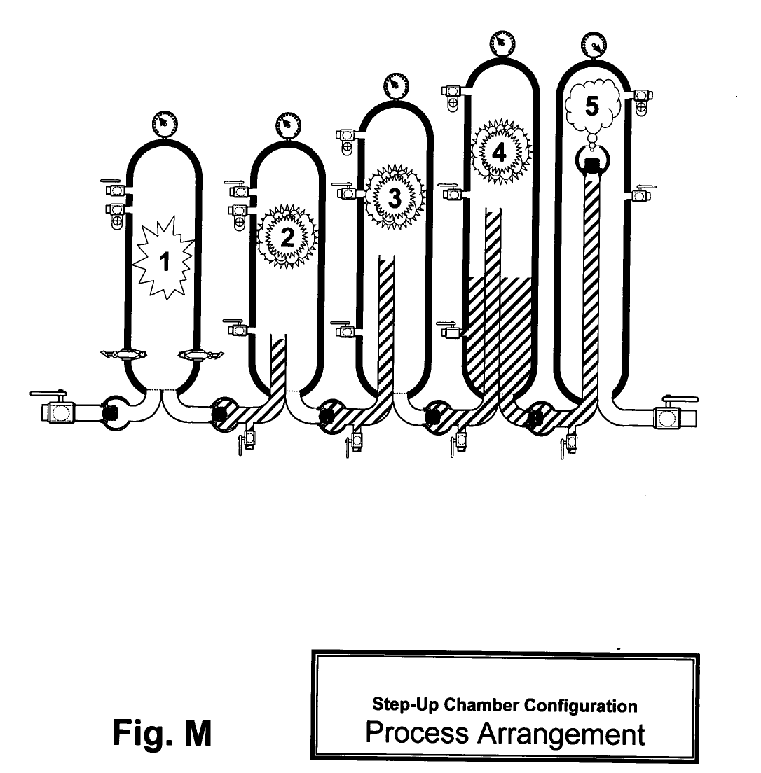

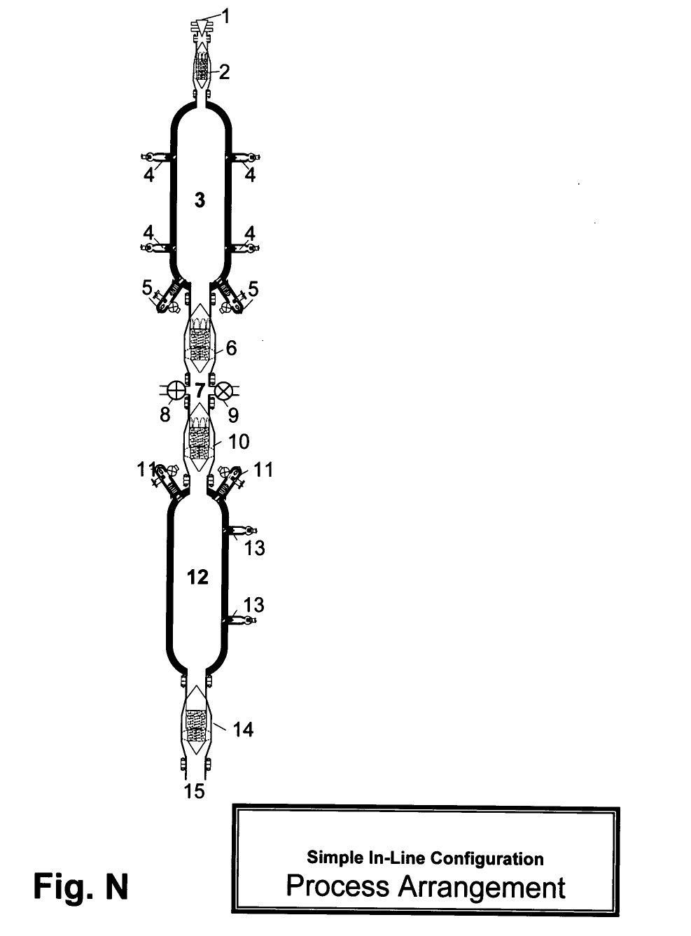

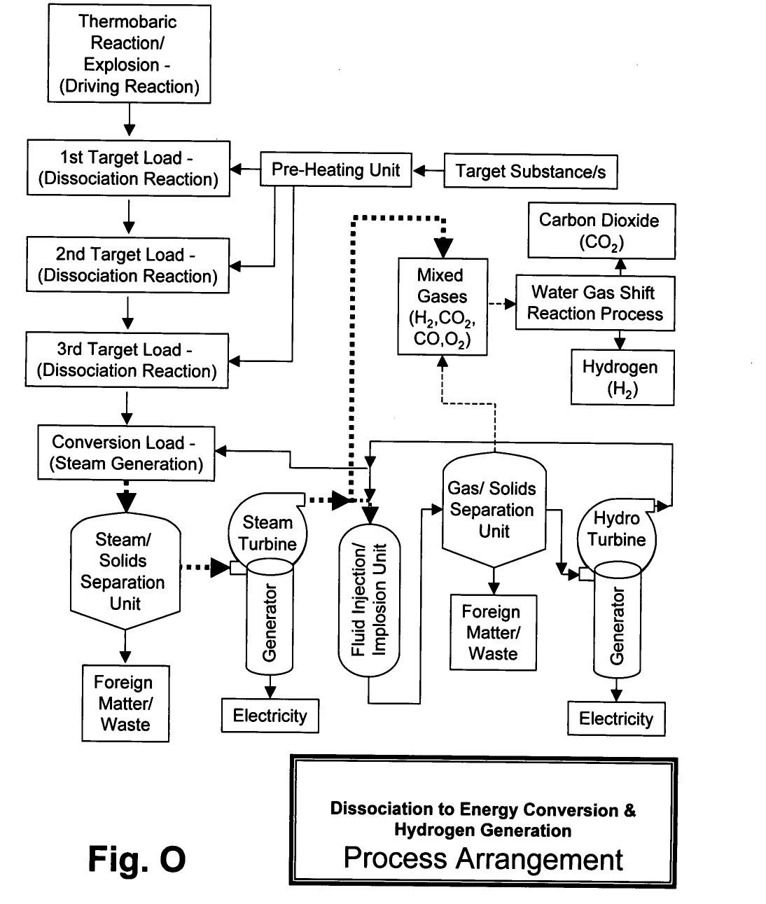

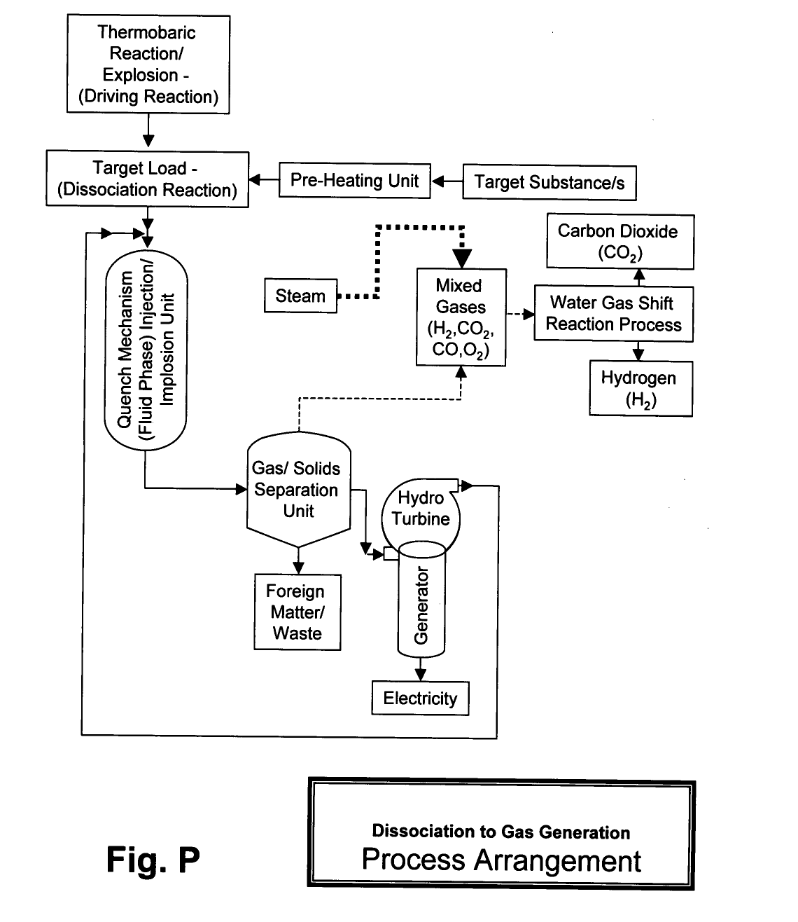

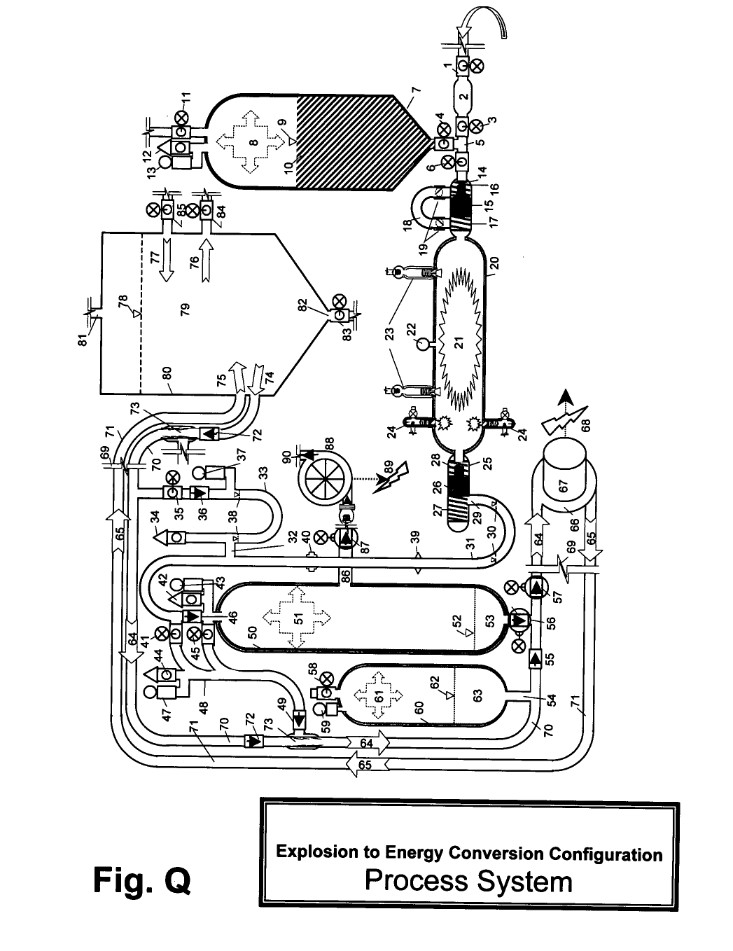

### PRIORITY CLAIMS

The invention of the present application claims priority based on U.S. Provisional Application Ser. No. 60/852,641, filed on Oct. 19, 2006, entitled “EXPLOGEN: An Energy Development Resource Method, System, Protocol, and Apparatus for the Thermo-Dynamic Generation, Dissociation, and/or Conversion of Steamn,” the entire disclosure of which is incorporated herein by reference.

Additionally, U.S. Patent Application Ser. No. 60/832,585, filed on Jul. 24, 2007, entitled, “EXPLO-DYNAMICS™: A Method, System, and Apparatus for the Containment and Conversion of Explosive Force into a Usable Energy Resource,” as well as its preceding U.S. Provisional Application Ser. No. 60/832,585, filed on Jul. 24, 2006, entitled, “EXPLO-DYNAMICS: A Method, System, Protocol and Apparatus for the Containment and Conversion of Explosive Force into a Usable Energy Resource,” collectively constitute a commonly owned, co-pending application, which is related to the present application and portions of which are also incorporated herein by reference.

### REFERENCES CITED

U.S. Patent Documents
U.S. Pat. No. 7,097,675 May 2002 Detering et al . . . 422/186
U.S. Pat. No. 6,349,538 February 2002 Hunter, Jr., et al . . . 60/204
U.S. Pat. No. 6,187,226 May 1999 Detering et al . . . 252/373
U.S. Pat. No. 5,456,066 October 1995 Smith, et al . . . 60/775
U.S. Pat. No. 5,313,915 May 1994 McDowell et al . . . 123/23
U.S. Pat. No. 5,271,357 December 1993 Hsu, et al . . . 123/23
U.S. Pat. No. 5,161,377 October 1992 Muller, et al . . . 60/653
U.S. Pat. No. 5,109,666 May 1992 Eickmann . . . 60/39.464
U.S. Pat. No. 4,907,565 March 1990 Bailey et al . . . 123/23
U.S. Pat. No. 4,809,503 March 1989 Eickmann . . . 60/39.464
U.S. Pat. No. 4,663,144 November 1985 McQuillan et al . . . 423/648R
U.S. Pat. No. 4,544,459 July 1984 Struck, et al . . . 204/103
U.S. Pat. No. 4,394,230 June 1981 Puharich . . . 205/341
U.S. Pat. No. 4,393,818 July 1983 Lefnaer . . . 123/23
U.S. Pat. No. 4,359,970 November 1982 Wolters . . . 123/23
U.S. Pat. No. 4,336,771 June 1982 Perkins . . . 123/23
U.S. Pat. No. 4,335,684 June 1982 Davis . . . 123/1A
U.S. Pat. No. 4,332,650 January 1981 Foh, et al . . . 205/338
U.S. Pat. No. 4,314,984 April 1980 Robert, et al . . . 423/579
U.S. Pat. No. 4,300,482 November 1981 Tinkham . . . 123/23
U.S. Pat. No. 4,237,105 June 1979 Bamberger et al . . . 423/306
U.S. Pat. No. 4,209,983 January 1990 Sokol . . . 60/325
U.S. Pat. No. 4,162,302 July 1979 Hirayama, et al . . . 423/579
U.S. Pat. No. 4,089,940 April 1977 Norman, et al . . . 423/658.2
U.S. Pat. No. 4,077,367 March 1978 Steiger . . . 123/23
U.S. Pat. No. 4,070,997 January 1978 Steiger . . . 123/23
U.S. Pat. No. 4,056,080 November 1977 Rutz, et al . . . 123/23
U.S. Pat. No. 4,052,963 October 1977 Steiger . . . 123/23

### OTHER PUBLICATIONS

Elaine S. Oran and Alexei M. Khokhlov. “Numerical Simulations of Gas-Phase Deflagration-to-Detonation Transition.” Laboratory for Computational Physics and Fluid Dynamics Naval Research Laboratory, Washington D.C., USA.
J. M. Austin, M. Cooper, S. Jackson, E. Wintenberger, J. E. Shepherd, B. Sturtevant. “Direct impulse measurements for detonations and deflagrations.” Graduate Aeronautical Laboratories, California Institute of Technology. Jul. 13, 2000. Explosion Dynamics Laboratory Report FM00-5
J. M. Grunthaner, S. I. Jackson, and J. E. Shepherd. “Design and Construction of an Annular Detonation Initiator.” Graduate Aeronautical Laboratories, California Institute of Technology, Pasadena, Calif. 91125. Sep. 28, 2001. GALCIT Report FM: 2001.005
Kenneth L. Cashdollar and Isaac A. Zlochower. “Explosion Temperatures of Metals and Other Elemental Dust Clouds.” Pittsburgh Research Laboratory, National Institute for Occupational Safety and Health. 2006.
C. K. Chan, I. O. Moen and J. H. S. Lee, Influence of Confinement on Flame Acceleration Due to Repeated Obstacles, Comb. & Flame 49, 1983, 27-39.
M. Kuzenetsov, V. Alekseev, A. BezmeInitsyn, W. Breitung, S. Dorofeev, I. Matsukov, A. Veser and Yu. Yankin, Effect of Obstacle Geometry on Behavior of Turbulent Flames, IAE-6137/3 FZKA-6328, 1999.
J. H. S. Lee, R. Knystautas and C. K. Chan, Turbulent Flame Propagation in Obstacle-Filled Tubes, In 20th Symposium (International) on Combustion, The Combustion Institute, 1985, 1663-1672.
C. K. Chan, J. H. S. Lee, I. O. Moen and P. Thibault, Turbulent Flame Acceleration and Pressure Development in Tubes, In Proc. of the First Specialist Meeting (International) of the Combustion Institute, Bordeaux, France, 1981, 479-484.
B. H. Hjertager, K. Fuhre, S. J. Parker and J. R. Bakke, Flame Acceleration of Propane-Air in Large-Scale Obstacled Tube, Progress in Astronautics and Aeronautics, Vol. 94, AIAA, 1983, 504-522.
A. E. Dahoe. “Laminarb umingvelocities of hydrogen-air mixtures from closed vessel gas explosions.” Faculty of Engineering, University of Ulster, FireSERT (Block 27), Co. Antrim, Shore Road, Newtownabbey BT37 0QB, Northern Ireland, UK Journal of Loss Prevention in the Process Industries 18 (2005) 152-166
I. O. Moen, J. H. S. Lee, G. H. Hjertager, K. Fuhre and R. K. Eckhoff, Pressure Development due to Turbulent Flame Acceleration in Large-Scale Methane-Air Explosions, Combustion and Flame, Vol. 47, 1982, 31-52.
H. Pfortner, H. Schneider, W. Drenkhahn and C. Koch, Flame Acceleration and Build-Up in Partially Confined Clouds, Presented at the 9th International Colloquium on Dynamics of Explosions and Reactive Systems, Poitiers, France, 1983.
A. A. Borisov, B. E. Gelfand, G. I. Skachkov et al., Selfignition of Gaseous Mixtures by Focusing of Reflected Shock Waves, Chimicheskaya Phisika, Vol. 7, No. 12, 1988, 1387.
A. Borisov, B. Gelfand, G. Skatchkov, et al., Ignition of Gaseous Combustible Mixtures in Focused Shock Waves, Current Topics in Shock Waves, Proc. of the 17th ISSW, AIP, N.Y., 1990, 696-701.
C. K. Chan, D. Lau, P. A. Thibault and J. D. Penrose, Ignition and Detonation Initiation by Shock Focussing, 17th International Symposium on Shock Waves and Shock Tubes, Lehigh University, Bethlehem, Pa., USA, Jul. 17-21, 1989, AIP Proceedings 208, 1990, 161-166.
C. K. Chan, Initiation of Detonation Induced by a Focused Shock Wave, 15th International Colloquium on Explosion and Reactive Systems, 1994.
O. V. Achasov, A. A. Labuda, O. G. Penzijakov and R. M. Pushkin, Shock Waves Initiation of Detonation in Semiclosed Cavity, Chimicheskaya Phisika, Vol. 12, No. 5, 1993, 714-716.
J. H. S. Lee and I. O. Moen, The Mechanisms of Transition from Deflagration to Detonation in Vapor Cloud Explosions, Progress in Energy and Combustion Science, Vol. 6, 1980, 359-389.
A. Veser, W. Breitung, G. Engel, G. Stern and A. Kotchourko, Deflagration-to-Detonation-Transition Experiments in Shock Tube and Obstacle Array Geometries, Report FZKA-6355, Research Center Karlsruhe, 1999.
A. D Craven and D. R. Greig, The Development of Detonation OverPressures in Pipelines, Chem E Symposium Series 25, 1968, 41-50.
S. M. Kogarko, Investigation of the Pressure at the End of a Tube in Connection with Rapid Nonstationary Combustion, Soviet Physics—Technical Physics (ZhTF) 28:2041.
M. D. Checkel and A. Thomas, Turbulent Combustion of Premixed Flames in Closed Vessels, Combustion and Flame, Vol. 96, 1994, 351-370.
S. H. R. Hosseini and K. Takayama “Implosion of a spherical shock wave reflected from a spherical wall.” Tohoku University Biomedical Engineering Research Organization, 2-1-1, Katahira, Aoba, Sendai 980-8577, Japan. 2004.
H. Miura and I. I. Glass, On the passage of a shock wave through a dusty-gas layer, Proc. R. Soc. Lond. A385, 85 (1983).
H. Miura, T. Saito, and I. I. Glass, Shock-wave reflection from a rigid wall in a dusty gas, Proc. R. Soc. Lond. A404, 55 (1986).
H. Miura and I. I. Glass, Oblique shock waves in a dusty-gas flow over a wedge, Proc. R. Soc. Lond. A408, 61 (1986).
H. Miura and I. I. Glass, Supersonic expansion of a dusty gas around a sharp corner, Proc. R. Soc. Lond. A415, 91 (1988).
B. Otterman and A. S. Levine, Analysis of gas-solid particle flows in shock tubes, AIAA J. 12(5), 579 (1974).
I. I. Glass. Over forty years of continuous research at UTIAS on nonstationary flows and shock waves. Shock Waves Journal. Springer Berlin/Heidelberg Volume 1, 1 Mar. 1991. pp. 75-86.
A. T-Raissi, N. Muradov, C. Huang, and O. Adebiyi. Hydrogen From Solar Via Light-Assisted High-Temperature Water Splitting Cycles. Journal of Solar Energy Engineering—May 2007-Volume 129, Issue 2, pp. 184-189.
E. S. Fishburne, K. R. Bilwakesh, and R. Edse. Gaseous Reaction Rates at High Temperature. I. The Dissociation of Carbon Dioxide. The Journal of Chemical Physics—Jul. 1, 1966—Volume 45, Issue 1, pp. 160-166.
Fishburne, E. S.; Bilwakesh, K. R.; Edse, R. “Shock tubes study of the dissociation of carbon dioxide.” Ohio State Univ. Aeronautical and Astronautical Research Labs, June 1966.
S. A. Losev and L. B. Terebenina. Kinetics of carbon dioxide dissociation behind a shock front. Journal of Applied Mechanics and Technical Physics. Volume 7, 4 Jul. 1966. pp. 97-100.
A. S. Baryshnikov, N. Yu. Vasil'ev and A. B. Safonov. Features of flow behind a shock wave with gas dissociation and ionization. Combustion, Explosion, and Shock Waves. Volume 23, 1 Jan. 1987. Pp. 93-95.
Sayler, M.; Hathiramani, D.; Carnes, K. D.; Esry, B. D.; Ben-Itzhak, I. Bond rearrangement during molecular dissociation; a sudden or slow process? J. R.
Macdonald Laboratory, Department of Physics, Kansas State University Publication: American Physical Society, 2002 Division of Atomic, Molecular and Optical, 05/2002.
Ben-Itzhak, I.; Sayler, A. Max; Leonard, M.; Maseberg, J. W.; Hathiramani, D.; Wells, E.; Smith, M. A.; Xia, Jiangfan; Wang, Pengqian; Carnes, K. D.; Esry, B. D. Bond rearrangement caused by sudden single and multiple ionization of water molecules. J. R. Macdonald laboratory, Department of Physics, Kansas State University, Nuclear Instruments and Methods in Physics Research Section B, Volume 233, Issue 1-4, p. 284-292.
C. J. M. Van Wingerden and J. P. Zeeuwen, Investigation of the Explosion-Enhancing Properties of a Pipe-Rack-Like Obstacle Array, Progress in Astronautics and Aeronautics Vol. 106, 1986, 53.
Eckhoff, R. F., Dust Explosions in the Process Industries (3rd Edition), Gulf Professional Publishing, 2003. ISBN 0-7506-7602-7.
S. H. R. Hosseini, K. Tanaka, T. Saito, K. Takayama. “Study of diverging and converging spherical shock waves induced by micro explosives” Interdisciplinary Shock Wave Research Center, Institute of Fluid Science, Tohoku University, 2-1-1, Katahira, Aoba, Sendai 980-8577 JAPAN
Warner, J. W.; Berry, S. R.; Hydrogen Separation and the Direct High-Temperature Splitting of Water. Journal of Hydrogen Energy, Vol. 11, No. 2, 1986. pp. 91-100.

### FIELD OF THE INVENTION

The present invention relates to energy producing systems and methods. More particularly, but not by way of limitation, the present invention relates to power generation systems and methods; in which, a series of process contained and controlled reactions, and/or explosion events, generate longer duration heat and pressure wave episodes (herein referred to as thermobaric reactions), which are enhanced by the process system to deliver a series of super-stimulated thermodynamic pulse cycles. These pulses of thermodynamic force drive the dissociation reaction of a target load. A target load, as referred to herein, is the measured substance body being subjected to the pulse heat reaction of the process for the purposes of driving a dissociation reaction.

When the target load is a substance containing hydrogen (such as water, methane, ammonia, methanol, etc.) the resulting hydrogen dissociation reaction can be directly discharged, or indirectly repeated one or more process cycles to step up the overall process energy output, and the discharged thermodynamic output is thereby routed into an energy transformation task, such as steam generation, thus providing a smooth delivery of power output for generating electricity and/or providing mobility to a vehicle or thrust/torque to a process system.

Likewise, when the target load is a substance containing carbon dioxide, the resulting dissociation reaction can be directly discharged into a sub-process (such as a water gas shift reaction and/or steam reformation process) for hydrogen recovery purposes. Still more particularly, the present invention relates to a method of using a wide variety of fuel substances, in either singular or combined mixtures; whereas, these fuel resources are suspended in the process system as a dispersed airborne fuel cloud, which may be comprised of pulverized solids and/or gases and/or aerosol droplets in a broad range of mixture scenarios designed to stimulate and maximize the desired thermobaric reaction or explosion output with the least amount of fuel being consumed to initiate said initial or driving reaction.

### BACKGROUND OF THE INVENTION

1. Prior Art

The word Hydrolysis is a compound word derived from the Greek words “hydro” and “lysis” and literally means the splitting of water. The concept of “water-splitting” or hydrolysis has been around for well over a century and a half. Since the origination of this concept, there have been two major categories of primary water-splitting related research. The first category studied revolved around the electrochemical process of Electrolysis. The second significant category of study has centered around a thermochemcial water-splitting process, which has previously been exclusively based upon a consistent source of heat via a nuclear reactor or solar concentrator to support the thermolysis of the molecular bonds via an endothermic reaction.

British scientist, Sir William Robert Grove first carried out experiments on electrolysis in 1839 and was the first to use electricity to split water into its subcomponents of hydrogen and oxygen.

In 1912, Irving Langmuir discovered that hydrogen could be dissociated by heat and published this discovery in “The Dissociation of Hydrogen Into Atoms,” Journal of American Chemical Society 37, 417 (1915). Later in 1924, Langmuir's research resulted in an invention called the Atom Arc or hydrogen torch (U.S. Pat. No. 729,185 filed Jul. 30, 1924 and U.S. Pat. No. 1,746,196 filed on Sep. 5, 1925) based upon this dissociation discovery; whereas this invention generated a temperature of 3,700 degrees centigrade. Langmuir's process involved passing a jet of hydrogen gas through an electrical arc, which in turn, momentarily dissociated the hydrogen (H₂→H+H−422 kJ). The hot plasma core of the arc provided the dissociation energy driving the endothermic reaction, and the dissociated atomic hydrogen produced by the reaction rapidly recombined, effecting the generation and release of extremely high temperatures. Langmuir's discovery has seeded interest to scores of scientists for nearly a century.

U.S. Pat. No. 4,141,805, filed in 1976 by Tihiro Ohkawa (General Atomic Company—Assignee) was the first thermochemcial dissociation process to receive a U.S. patent. The current invention differs substantially from this, and other like inventions, which were based upon the foundational concepts of using nuclear and/or solar energy as a constant reaction heat source.

Although, thermo-chemical water-splitting technology dates back to the 1970's, the various related inventions patented since this time all seem to share a common motive of capturing the released hydrogen for subsequent usage purposes. The current invention (referred to herein as the Xplogen process and/or system) again differs fundamentally from these prior art endeavors; in that, in one or more embodiments of the current invention, the dissociated release of gases are consumed by the process as an intermediate energy release mechanism for the purpose of generating more heat, steam, and/or pressure for energy conversion purposes. Also unlike these former water-splitting efforts, certain embodiments of this invention use the thermal energy spikes of a series of pulse or explosion episodes, or batch thermobaric reactions, to achieve the impulse temperatures necessary to facilitate the dissociation of the hydrogen and/or gaseous components held within the water, or other hydrogen containing target substance (load) being subject to the focused energy of the driving reaction of the process system.

Similar to water-splitting, carbon dioxide dissociation is also a reaction which requires intense heat. The present invention's use of a superheated pulse also finds application toward the task of dissociating a target load (containing carbon dioxide) for the purposes of generating an initial reaction to liberate carbon monoxide and oxygen; whereas, a subsequent water shift reaction generates hydrogen. Likewise, the current invention differs fundamentally from all prior art endeavors; in that, the heat source is a superheated pulse of energy generated via a process contained explosion and/or thermobaric reaction as opposed to conventional, consistent heat-based process reactions, which have been attempted since the 1960s.

Thermobaric is a compound word originating from the Greek terms “thermo” for heat and “baric” for pressure. The term “Thermobaric” has historically been applied to the science of explosions with long wave energy output characteristics. Thermobaric weapons originated over the past seven-year period and have been applied in modern military warfare technology by several nations throughout the world including the United States, Russia, and China.

The Xplogen™ invention described herein and the co-pending Explo-DynamicS™ invention patent application are each applications of Thermobaric Energy System™ technologies; whereas through these inventions, thermobaric science has now been first applied to the generation of energy for producing electricity and/or providing motive force for a vehicle or process system.

2. Problems with Prior Art

Past dissociation research efforts have attempted to use stable heat sources, such as combustion or artificial heat from nuclear reactions, concentrated solar or electrical plasma fields to generate a consistent heat source and therein have attempted to support the dissociation reaction to proceed as a continual process. Although, certain embodiments of the Xplogen process could, and undoubtedly will, operate as a heat source for thermo chemical dissociation cycles in a continuous or “pass thru” process mode basis, Xplogen's greatest initial potential is offered in and thru certain embodiments described herein which incorporate a controlled series of batch process, thermobaric pulse reactions. In this manner of operation, the individual batch reactions will collectively work together to use the pulse release of energy from each individual reaction unit in a process-controlled orchestration of firing sequences otherwise designed to smooth out the overall process power delivery into a steady generation of steam and/or torque for energy conversion purposes to create electricity and/or provide mobility for a vehicle or process.

The Xplogen process can be used in conjunction with any of the currently recognized thermo chemical water-splitting cycles (approximately 200 scientifically identified cycles) as a reaction-supporting heat source and brings the feisability of direct thermodynamic dissociation within reach as a safe and economical energy development option. It also bears mentioning that even though the technology of water-splitting was revealed during the seventies and has a trail of patented ideas dating back to this era, that none of these ideas has yet to result in a viable process for economically generating energy.

For example, the two most notable thermochemical water-splitting cycles in the world today are the General Atomic's Sulfur Iodine Cycle and the University of Tokyo's Adiabatic UT-3 (Calcium Bromide) Cycle. These thermochemcial water-splitting cycle examples report the highest conversion efficiencies and, as yet, no hydrogen production or electrical generation facility has ever commercially operated upon either of these technology platforms.

Xplogen's process will allow many of these previously identified thermochemcial water-splitting cycles to operate feasibly, especially if the intent of the disassociation process is to create a fuel for immediate consumption and/or serve to propagate and sustain a reaction designed to produce more heat and/or steam with less fuel.

### SUMMARY OF INVENTION

### Foundational Science

Water contains an enormous amount of energy when it is disassembled into its gaseous components. When dissociated, one cubit foot of water contains approximately 1,578 cubic feet of hydrogen and 789 cubic feet of oxygen and when liberated, these gasses have a heat value of approximately 546,608 BTUs.

Obviously, hydrogen is a desirable fuel; in that, it has a wide range of explosivity concentrations and contains much heat value. When dissociated, one gallon of water possesses as much heat value contained within its nearly one kilogram of hydrogen sub-component, as does approximately a half-gallon of gasoline.

According to the U.S Department of Energy's Office of Energy Efficiency and Renewable Energy (DOE-EERE), thermo chemical water-splitting normally occurs in a temperature range between 500-2,000° C. However, thermal decomposition or thermolysis of water usually occurs significantly at 2,500° C. or above without the addition of inorganic salt or catalyst solutions. Additionally, the calculated result of an equilibrium composition for water vapor, hydrogen, and oxygen suggests that temperatures above 2,700° C. would be required for the sustained dissociation of gases from water without the thermochemcial influence.

At temperatures of approximately 1,527° C., without the influence of chemical additives, water vapor or steam begins to dissociate into a mixture of H₂, O₂, H₂O, O, H, and OH. The extent of this dissociation activity increases as the temperature increases and the pressure decreases.

In like manner, carbon dioxide splitting is a thermolysis process, which can either be a straight thermal reaction and/or can be thermochemically enhanced by adding inorganic catalysts to reduce the amount of thermal energy required for driving the dissociation reaction. It is an embodiment of the present invention to supply pulse energy discharges to support the dissociation of carbon dioxide in either a straight thermal or thermochemcially assisted dissociation process for the purpose of recovering hydrogen through a water gas shift reaction based sub process. This second stage reaction uses high temperature, high-pressure steam to transform the process intermediate, carbon monoxide, into gaseous hydrogen and carbon dioxide.

### Xplogen—Introduction

Xplogen is a name used herein to identify the new energy technology invention described within this patent application. Xplogen is an innovative process where a thermobaric reaction or explosion is propagated within a confined process system using a solid, liquid, and/or gaseous fuel (or any singular version or mixture combination thereof). The Xplogen process stimulates and adiabatically enhances the resulting thermodynamic output of the energy generation reaction series. The released energy and force from each explosion episode is then directed into a controlled and measured quantity of a target load (or targeted volume of substance, which contains hydrogen components subject to dissociation in certain process embodiments) thereby vaporizing and subjecting the target substance to thermolysis, thus generating a dissociation reaction.

In certain embodiments of this invention wherein a thermodynamically driven dissociation reaction results in hydrogen gas and oxygen being liberated from the vaporization and/or thermolysis of target load, a secondary or carryover reaction ensues being fed from the dissociated hydrogen and/or the heat of recombination thereof. Also, in certain embodiments of this invention, the next stage of Xplogen's process system, a conversion load resistance front is met by the advancing blast wave resulting in a greater quantity of steam being generated as the reaction front is eventually overwhelmed by the thermal buffering of this conversion load reservoir. In this manner, the initial fuel is used to create more energy from the dissociation reaction and the net impact of the process reaction is a substantially larger energy conversion factor given the amount of initial fuel consumed to drive the process reaction sequence. The additional energy value is contributed by the dissociation and/or recombination reactions as well as the subsequent thermal conversion of the released gasses.

In certain embodiments of this invention, a relatively small measure of fuel is ignited into a thermobaric reaction or explosion, thus driving the subsequent dissociation reaction/s. Likewise when hydrogen and/or oxygen is dissociated from a target substance by being subjected to the initial explosion's blast wave forces, these gasses ultimately are ignited (unless intentionally quenched) by the residual heat from the initial driving explosion episode and are consumed as additional fuel thus initiating a secondary or carryover explosion episode.

In certain embodiments of this invention, the carryover explosion episode is an accelerating deflagration reaction and/or has passed a point of transition and has become a supersonic detonation and either of which reactions stimulate a dissociation reaction and collectively carry more net energy than that of the original explosion episode. As the initial driving explosive force is routed into a target load (a body of fluid, vapor, fog, gas and/or solid substance/s) the hydrogen contained therein is dissociated and thereby converted into additional energy, which is translated into steam and/or quenched to produce gases.

### Xplogen's Differences

Xplogen's technology differs substantially than other previous attempts at dissociation and/or water-splitting. There are five major categories of differences which clearly establish the novelty of this absolutely unique technology for energy generation purposes.

### Difference No. 1—Heat Source

Xplogen's process initiates and stimulates a thermobaric reaction or explosion within a contained process system. This controlled explosion episode provides the thermal driving force for the subsequent process reactions.

### Difference No. 2—Thermal Stimulation

Xplogen's process stimulates an enhanced heat pulse from a thermobaric reaction or explosion event within a contained process system. This accelerated release of thermal energy supplies the superheated pulse of energy necessary to support the dissociation reaction/s.

### Difference No. 3—Energy to Load Balancing

Xplogen's process matches the application of thermobaric or explosive energy to the target loads being subjected to hydrogen dissociation via thermolysis and in one or more embodiments of this invention may include both water-splitting reaction and steam conversion reaction events.

### Difference No. 4—Process Arrangement

Xplogen's process is unlike any other previous design related to generating either thermal or thermo chemical dissociation reactions. In one or more embodiments of this invention, which operates as a series of batch reactions as opposed to a continuous reaction, the stimulated thermal pulse is directly transmitted to the dissociation target media. The driving explosion or thermobaric reaction, as well as the subsequent follow-up dissociation episode and/or recombination components, can reach very high temperature ranges for short periods of time. This momentary superheated pulse of energy allows the process system an opportunity to cool between cycles and prevents the deterioration of the containment system and other process components, which would occur in a continuous heat source reaction mode of operation.

### Difference No. 5—Fuel Source

Xplogen's process can use a wide variety of fuel types and/or mixtures to initiate and stimulate explosion episodes within a contained process system. Since explosions differ somewhat from combustion events and thermobaric explosions differ from most other types of explosions, many new types of fuels can be considered and new efficiencies for traditional fuels are made possible by these unique process attributes.

### Hyper-Thermodynamic Stimulation Methods

It is generally understood that explosions occurring within a confined vessel generate an impulse of pressure and heat; whereas, the temperatures achieved in the impulse moment exceed those associated with the normal combustion of the fuel. The pressure of the confined explosion episode is a component of the temperature increase.

Recent research findings have shown that manipulated impulse temperatures can almost double the normal heat of combustion for a certain fuel-air mixtures. In fact, many fuel mixtures can be stimulated to exceed 4,000° Fahrenheit and some studies have demonstrated impulse spikes above 7,500° F. These impulse events are of short duration and are usually measured in terms of milliseconds; therefore the respective containment vessel is not melted, sublimed, or otherwise destructively compromised by the episode as would quickly be the case in the event these temperatures were constant over longer durations.

The present invention makes use of this unique energy impulse opportunity by matching the output of the thermodynamic release episode to the work (dissociation and/or steam conversion load) to be accomplished. This impulse occurs so quickly that normal heat losses to the cylinder walls or system componentry are not as pronounced as those attributable to these components within a regular internal combustion engine. Thus in one or more of the embodiments of this invention, the power generated is rapidly and more efficiently translated into the desired work of dissociation and/or the conversion of steam.

In several embodiments of this energy production invention, the process system and the procedure employed, collectively stimulate an accelerated reaction of the explosion episode and raise the heat impulse of the reaction's output. Several process mechanisms participate in this function:

### 1. Adiabatic Influence

As air is compressed, it heats up in proportion to the force of compression. This compression heat phenomena, commonly referred to as adiabatic pressure, provides the fuel ignition mechanism for regular diesel engines. Adiabatic influence is an integrated component of the current invention's process as well; however, the adiabatic stimulation role in this invention does not serve primarily as an ignition mechanism, but rather as a super-heating mechanism. When an explosion occurs inside a contained process system, in an instant much compression occurs thus additional heat is added to the reaction. This phenomenon is commonly referred to as pressure piling or pre-compression. Accordingly, this invention is designed to adiabatically influence an increase in the thermal output of each explosion cycle, which translates into more impulse heat per unit of fuel consumed.

Adiabatic compression forces are difficult to calculate given the many process geometries and configuration options available, but it should be noted that combustion heat increases of 1,000° F. are not uncommon for most contained, but unstimulated, explosion events. Even still, attention to explosion chamber configuration details and blast wave reflection patterns can boost this induced adiabatic shock compression temperature increase substantially and accelerate the violence of the explosion event as well. The present invention's adiabatic compression efficiency is a process geometry and configuration related variable, which offers many efficiency advantages for increasing fuel input-to-energy-output process efficiencies and is, in effect, a measure of the strength of the imploded shock wave. Other factors such as the angle and depth of the reflection components as well as the nature of the fuel source mixture, also contribute to the acceleration and intensity of the adiabatic reaction.

### 2. Shockwave Acceleration Influence

Although the shockwave episode of an explosion is an integrated component of the adiabatic influence inside the process system by acting as impulse piston of sorts, the shockwave mechanics themselves contribute to the rate of the explosion's reaction and the violence thereof. Accordingly, an explosion's violence is the recognized measure of the maximum rate of the explosion's pressure rise at a constant volume. This violence characteristic responds to stimulation mechanics and accelerates the reaction's speed, heat, and power.

Inside a typical confined explosion episode many mechanisms are occurring simultaneously which impact the explosion's heat and pressure output. The expansion of reactants as they are combusted to form products is referred to as volumetric dilatation, which occurs when a deflagration causes compression waves to emanate from the explosion's front. These compression forces coalesce into shock waves ahead of the flame front, which causes temperature, pressure, and velocity increases in the unreacted gas zone. While some flames accelerate as the pressure increases, others will decelerate; however, increasing temperature generally causes a net acceleration of the flame front.

The speed of the particle velocities induced by the shock compression episode also acts to raise the Reynolds number of the unreacted flow into which the flame front quickly propagates. As the Reynolds number increases sufficiently, the explosion's flow will transition from laminar to turbulent with a synergistic increase in flame velocity and the associated energy release rate due to turbulent structures created in the episode.

Reflected shockwaves interact with the flame front giving rise to Rayleigh-Taylor interface instability, which causes a distortion of the flame-front. Shock-flame interaction is typically found in confined situations and small changes in the process system's geometry can change the explosion output scenario significantly.

In one or more embodiments of this invention, the compression waves generated by the flame front reflect off of solid boundaries within the process system and both the surface area of the flame front increases as well as the energy release rate as the flame front accelerates. The distorted pattern of the explosion episode gives rise to increased turbulence, which, in turn, further accelerates the flame front.

In one or more embodiments of this invention, obstacles are added to the internal confines of the process system to transform the kinetic energy of the explosion flow into large-scale turbulence, which cascades into smaller and finer scales. These large-scale turbulent structures cause an even greater increase in flame front surface area; whereas, the smaller structures enhance the thermal transport processes by inducing an episode of turbulent mixing at the molecular level. Collectively, these mechanisms result in a net increase to the energy release rate as well as the effective propagation velocity of the flame front.

### 3. Deflagration to Detonation Transition (DDT)

Deflagrations are subsonic explosions and detonations are supersonic explosions. A Deflagration to Detonation Transition (DDT) process episode occurs when an explosion's speed rises from a deflagration to a detonation, which is the natural result of the enhanced adiabatic and shockwave influences previously outlined. In one or more embodiments of this invention, stimulation of DDT explosion episodes is possible given the respective fuel mixture scenario. Although, the characterization of the ‘state’ of a fuel laden particulated cloud is far more complicated than characterizing the ‘state’ of a premixed quiescent gas mixture, a mixed fuel DDT initiation event can be accomplished with a particle-laden fuel cloud, even if it becomes necessary (due to the nature of a particular fuel mixture) to add small amounts of a combustible gas to the fuel cloud atmosphere. Accordingly, a DDT reaction cycle offers certain energy output advantages over that of a regular deflagration explosion because very high-pressure loads can be achieved through this phenomenon (in the order of 50 bars), which translates into a super-heated output scenario.

### BRIEF DESCRIPTION OF THE SEVERAL VIEWS OF THE DRAWING

Figure A Sheet # 1 of 17 Xplogen™ Thermobaric/Explosion Impulse Hydrogen Dissociation Process Cycle—Single Stage Dissociation

Figure B Sheet # 2 of 17 Xplogen™ Thermobaric/Explosion Impulse Hydrogen Dissociation Process Cycle—Multi Stage Dissociation

Figure C Sheet # 3 of 17 Xplogen™ Thermobaric/Explosion Impulse Hydrogen Dissociation Process Cycle—Multi Stage Dissociation—Step Up Reaction

Figure D Sheet # 4 of 17 Xplogen™ Thermal Conversion—Direct Hydrogen Gas Process Cycle

Figure E Sheet # 5 of 17 Xplogen™ Hydrothermic Engine™ Process Cycle

Figure F Sheet # 6 of 17 Xplogen™ Thermobaric/Explosion Impulse Carbon-Dioxide Dissociation Process Cycle

Figure G Sheet # 7 of 17 Xplogen™ Pulse Reaction to Dissociation to Energy Process System

Figure H Sheet # 8 of 17 Xplogen™ Hydrothermic Engine™ Configuration Process System

Figure I Sheet # 9 of 17 Xplogen™ Hydrogen Gas Generation Configuration Process System

Figure J Sheet # 10 of 17 Xplogen™ Hydrogen Via CO₂ Dissociation Configuration Process System

Figure K Sheet # 11 of 17 Xplogen™ Tri-Chamber Configuration Process Arrangement

Figure L Sheet # 12 of 17 Xplogen™ Simple Dual-Chamber Configuration Process Arrangement

Figure M Sheet # 13 of 17 Xplogen™ Step-Up Chamber Configuration Process Arrangement

Figure N Sheet # 14 of 17 Xplogen™ Simple In-Line Configuration Process Arrangement

Figure O Sheet # 15 of 17 Xplogen™ Dissociation to Energy Conversion & Hydrogen Generation Process Arrangement

Figure P Sheet # 16 of 17 Xplogen™ Dissociation to Gas Generation Process Arrangement

Figure Q Sheet # 17 of 17 Xplogen™ Explosion to Energy Conversion Configuration Process System

### DETAILED DESCRIPTION OF THE INVENTION

The current invention's process system comprises a means and method of introducing, producing, and harnessing a thermodynamically driven series of dissociation reactions. This process is referred to herein as Xplogen™.

In certain embodiments of the Xplogen's process, which support a water-splitting reaction, hydrogen gas and oxygen are liberated from the vaporized target load and a secondary or carryover explosive reaction ensues being fed from the newly dissociated hydrogen. Within the next stage of the process system, a conversion load resistance front is then met by the advancing blast wave and more steam is generated as the reaction front is eventually overwhelmed by the thermal buffering capacity of the conversion load's fluid reservoir thus inducing a littoral reaction and a conversion of the fluid into steam pressure. In this manner, the initial fuel is used to create more energy from the dissociation or water-splitting reaction and the net impact realized is a substantially larger energy output and/or steam conversion factor given the amount of initial fuel consumed to drive or initiate the process reaction. The additional energy value is contributed by the hydrogen dissociation and/or water-splitting phenomena.

### Thermal Dissociation

At temperatures of 3,500° K., hydrogen or carbon dioxide readily dissociate. At 1,600° K., methane likewise efficiently dissociates and slightly higher temperatures liberate hydrogen from ammonia and hydrogen sulfide. Two major obstacles have historically blocked dissociation energy production processes from being either scientifically possible or commercially feasible. These obstacles are the intense heat source requirement as well as the inability to structurally contain the heat source.

The present invention differs from prior dissociation process attempts in the sense that the driving heat for the dissociation reaction is generated in a pulse of only milliseconds in duration. The invention's use of a thermobaric reaction or explosion series is a unique improvement to prior art endeavors and overcomes the historical obstacles by achieving a impulse energy release of sufficient temperature to dissociate a measured target substance. Additionally, the duration of the reaction is brief enough to allow adequate cooling between cycles to prevent the thermal destruction of the process system. Further, the present invention can make use of established thermochemcial solutions and/or catalyst substances allowing the dissociation process to occur at lower temperatures. This feature gives the process a greater degree of flexibility and variation of fuel types for driving Xplogen's process of multiple orchestrated dissociation reactions to deliver a smooth, safe, and efficient delivery of output in the form of hydrogen and/or energy for generating electricity or proving motive force to a vehicle or a process.

Xplogen's pulse dissociation process can be applied to a variety of compounds. The following Table 1.0 illustrates the basic dissociation reaction sequence of several compounds without the application of thermochemcial substances:

TABLE 1.0
Xplogen's Dissociation Sequence Examples

| Dissociation | | Stage 1 Reaction | Stage 2 Reaction |
|---|---|---|---|
| Process | Driving Influence | Dissociation | Water Gas Shift |
| Water-Spitting | Xplogen Superheated | 2 H₂O → 2 H₂ + O₂ | |
| | Pulse → | | |
| Carbon Dioxide | Xplogen Superheated | CO₂ → CO + O₂ | CO + H₂O → CO₂ + H₂ |
| Splitting | Pulse → | | |
| Methane | Xplogen Superheated | CH₄ → C + 2 H₂ | |
| Splitting | Pulse → | | |
| Water & | Xplogen Superheated | CH₄ + H₂O → CO + 3 H₂ | CO + H₂O → CO₂ + H₂ |
| Methane- | Pulse → | | |
| Splitting | | | |
| Ammonia | Xplogen Superheated | 2 NH₃ → 3 H₂ + N₂ | |
| Splitting | Pulse → | | |
| Hydrogen | Xplogen Superheated | 2 H₂S → S₂ + 2 H₂ | |
| Sulfide Splitting | Pulse → | | |

### Xplogen Process Cycle for Dissociation of Hydrogen

In Xplogen's Water-Splitting Process a thermal impulse of released thermobaric reaction or explosion dissociates the water into hydrogen and oxygen.

Superheated Pulse→2H₂O→2H₂+O₂

### Xplogen Process Cycle for Dissociation of Carbon-Dioxide

In the first phase of Xplogen's Carbon-Dioxide Splitting Process a thermal impulse of released thermobaric reaction or explosion dissociates the carbon dioxide into carbon monoxide and oxygen.

Superheated Pulse→CO₂→CO+O₂

### Post-Dissociation Conversion (Xplogen Stage 2 Reaction)

The residual dissociation reaction heat generated by the Xplogen process provides the thermal energy necessary to support a high temperature water gas shift reaction or a (HT) CO shift conversion reaction. In this manner the dissociated release of carbon monoxide is subjected to pressurized steam and a water gas shift reaction results, which translates the carbon monoxide into hydrogen gas and carbon dioxide.

For example:

CO+H₂O→CO₂+H₂

### The Xplogen Dissociation Process Cycle

In one or more embodiments of the present invention, the Xplogen Dissociation Process Cycle begins with fuel being consumed and ends with energy being generated in the form of steam to drive a turbine or process for producing electricity, mobility for a vehicle or watercraft, and/or power for a process. Figures: G, H, I, J, O, P, & Q offer diagrams of several process configurations and identify some component mechanisms of the system and serve to better visualize and understand the following steps:
a) A contained process system is configured and provided to supply and support the energy conversion process (Figures: G, H, I, J, O, and P);
b) An ignitable fuel (solid, gaseous, and/or liquid or any singular or combination mixture thereof) is injected into the first stage ignition chamber (Note: Figure K, Items: 4,5, & 6; and Figure N, Items: 1 & 2);
c) A quantity of air and/or another oxidizing substance is injected into the ignition chamber (Note: Figure K, Items: 4,5, & 6 (8*); and Figure N, Items: 1 & 2);
d) An ignition mechanism is triggered by the process control computer system to produce a spark or other ignition energy into the ignition chamber's internal atmosphere (Note: Figure K, Item 7; and Figure N, Item 5);
e) The fuel cloud is ignited and an explosive reaction is initiated within the confines of the ignition chamber (Note: Figure K, Item 1; and Figure N, Item 3);
f) The blast wave initiated within the confines of the ignition chamber is stimulated by internal obstructions and geometries designed to increase turbulence (Note: Figure K, Item I; and Figure N, Item 3);
g) The shock wave initiated within the confines of the ignition chamber is used to simulate a piston effect by creating an imploding annular shock wave compressing an air pocket ahead of the blast wave (Note: Figure K, Item I; and Figure N, Item 3);
h) The imploding air pocket is forced into one or more parabolic reflection structures within the reaction cylinder thereby creating an adiabatically enhanced thermal output effect as the blast wave overcomes this zone of stimulation and retreats in the path of least resistance (Note: Figure K, Item 1; and Figure N, Item 3);
i) The intensified blast wave travels to and through a pressure relief mechanism (Note: Figure K, Item 10 & 11; and Figure N, Item 6);
j) The intensified blast wave travels to and through a confined target load chamber (Note: Figure K, Items 12 & 15; and Figure N, Item 7);
k) The stimulated thermal energy pulse causes a flash conversion the target load and excessive thermal forces within the ensuing blast wave dissociate the hydrogen and/or carbon dioxide and/or other gases contained within the target substance (Note: Figure K, Item 12; and Figure N, Item 7);
l) The dissociated gases (such as hydrogen, oxygen, carbon monoxide, and/or residual water vapor are propelled by the blast wave from the target chamber through a pressure relief mechanism into the reaction or conversion chamber (Note: Figure K, Items: 12, 15, 16, & 2; and Figure N, Items: 7, 10, & 12);
m) When the dissociated gases are released from a carbon-dioxide containing target load and the process intent is to produce hydrogen gas, the dissociated carbon monoxide is then released to a water shift reaction based sub-process where steam reforming or water gas shift reaction translates the carbon monoxide into hydrogen gas and carbon dioxide (Note: Figure M, Items:);
n) When the dissociated gases are released from hydrogen-containing target load and the process intent is to produce hydrogen, the heat from the ensuing blast wave is quenched in a liquid or gaseous quench mechanism and the dissociated and/or recombined hydrogen gas and other liberated gases are separated and removed in a gas separation and capture sub-process (Note: Figure M, Items:);
o) When the dissociated gases are released from hydrogen-containing target load and the process intent is to produce energy, the heat from the ensuing blast wave ignites the dissociated and/or recombined hydrogen gas and the liberated oxygen supports and enhances the thermal conversion of the secondary (or carry over) explosion, which results from the dissociation or water-splitting reaction (Note: Figure K, Items: 12, 15, 16, & 2; and Figure N, Items: 7, 10, & 12);
p) The secondary explosion is thermodynamically stimulated by the process configuration designed to increase turbulence and adiabatic influence (Note: Figure K, Item 2; and Figure N, Item 12);
q) The expanded gas release of the secondary explosion is routed into and through one or more secondary loads of fluid also within the confines of the process system (Note: Figure K, Items: 2, 17, & 22);
r) The stimulated advancing thermal energy pulse causes a littoral reaction, as it violently flash converts the secondary fluid load into steam pressure (Note: Figure K, Items: 12, 15, 16, & 2; and Figure N, Items: 7, 10, & 12);
s) The steam generated in the conversion of the secondary fluid or conversion load reservoir is driven into and through another pressure relief mechanism into a steam pressure reservoir (Note: Figure K, Items: 17, 22, 23, & 3; and Figure N, Items: 14 & 15);
t) The steam pressure generated is discharged into a turbine or other steam-to-energy mechanism for creating torque or thrust for providing motive force to a generator thus producing electricity or providing propulsion to a vehicle, watercraft, and/or process (Note: Figure K, Items: 17, 22, 23, & 3; and Figure N, Items: 14 & 15); and
u) As steam pressures are being relieved from the system's reservoir/s, fuel air/oxidizer, and target load re-charging is initiated so the next energy production, cycle can be initiated (Note: Figure K, Items: 1, 4, 5, 6, 12, & 14; and Figure N, Items: 1, 2, 3, 7, & 8).

### Thermal Stimulation in Xplogen's Process

The present invention's process contains three major elements of thermal stimulation to enhance the temperature output of its reaction. These elements are:
1. Fuel Application
2. Induced Turbulence
3. Adiabatic Compression

### Fuel Application

Xplogen's process makes use of conventional fuels and unconventional fuels alike. Since an explosion differs somewhat than combustion, the types of fuels may vary, as will their mixtures. Explosions are not only influenced by the BTU value of the fuel, but explosive pressures and reaction speeds vary according to the fuel type chosen; in that, many fuels with lower BTU values have higher maximum explosive pressure ratings. These unique characteristics lend themselves to a variety of potential process arrangements and a multiplicity of fuel combinations, which can be applied for energy conversion purposes in both the Xplogen process system's methodology.

Xplogen's system allows for a wide range of fuels to be blended and processed into scaled thermodynamic reactions. Conventional fuels such as coal dusts and methane can be easily processed, as can be an entire new host of renewable energy fuels such as agricultural waste, such as corncobs and stalks. This invention can apply blends of conventional fuels and provide a means for unconventional or alternative fuels to become commonplace energy feedstocks of the future.

### Induced Turbulence

Xplogen's process efficiency benefits from fuel mixture variations that enhance the violence of the explosion as well as its use of internal process configurations designed to reflect the blast wave pattern and route the blast wave through a series of internal obstructions. These obstructions are designed to collectively increase the violence and adiabatic pressure of the explosion event and thus influence and accelerate the thermal energy output of the explosive reaction.

### Adiabatic Compression

Xplogen's process accelerates and enhances the thermal output of the explosive reaction. The internal geometry of Xplogen's process configurations is designed to generate an imploding annular shock wave, which allows for and induces the implosion of fuel laden air pocket/s being compressed by the advancing shock wave and thus increasing the violence and temperature of the ensuing blast wave. By making use of parabolic focusing wall/s, parabolic reflector panels and/or parabolic end caps within its process confines, Xplogen's imploding shock geometries force the pocket/s of fuel laden atmosphere/s into ever-decreasing area/s, which creates far more compression compared to that of system's employing planar geometries. This force of compression is capable of generating regions of extremely high energy density to the extent that, in certain fuel specific atmospheres, the air pocket laden with fuel may explode in advance of contact with the ensuing flame front of the blast wave.

In this adiabatic stimulation process, the increase in compression forces accelerates the shock wave, which accordingly acts to further accelerate the post-shock pressure and temperature. In Xplogen's process, this cycle continues on throughout the implosion process and results in comparative high post-shock pressures, and temperatures, as the driving wave radius approaches zero. The resulting reaction is a high temperature burst of explosive force that thermally spikes into temperature zones that are unachievable by standard combustion methods.

### Hyper-Thermodynamic Stimulation Mechanisms

Several factors participate in this invention's ability to adiabatically influence a spike impulse discharge of superheated gases. The present invention makes use of a variety of structural, procedural, and chemical mechanisms to stimulate a series of thermal pulse episodes designed to accelerate the inter-related adiabatic influence, violence, and pressure of the contained process explosion sequence and the subsequent thermodynamic output thereof.

### 1. Structural

Internal Obstructions
Parabolic Reflection Panels/End Caps
Parabolic Focusing Rings/Walls
Multiple Ignition Source Scenarios
Tubular Ignition Chamber (Length Over Diameter)
Pressure Relief Blast Valves
Geometric Restriction Zones Within Process

### 2. Procedural

Pre-Pressurization of the Ignition Chamber and/or Process System
Convergence of Blast Patterns
Multiple Fuel Cloud Ignition Points
Induced Shockwave Collision Fronts
Manipulation and Control of System Operating Temperatures

### 3. Chemical

Blending of Fuels
Addition of Oxidizing Substances

### Xplogen's Process of Balancing Force to Load

As we have learned through our nation's history of testing nuclear weapons over bodies of water, the body of water acts to buffer and cool the thermal water-splitting reaction; otherwise, a runaway reaction of water-splitting would continue to occur until all of the water source being used as fuel would thereby be extinguished. Also from military history, we have learned that substantial steam volume can be created through an underwater blast and consequently, that the expanded steam bubble would then, almost as rapidly, disappear by condensing upon itself as the cooling effect of the surrounding body of water resulted in the rapid compression of the imploding steam bubble.

Xplogen's process uses two controlled loads (a target load and a conversion load) each matched to the explosive energy of the driving thermo-dynamic reaction. The first load is the target load substance, which is subject to initial blast wave impact and is also subject to the dissociation and/or water-splitting reaction stimulated by the intensified heat pulse of the driving explosion. The second load, also known as the conversion load, receives the energy released from the dissociation of hydrogen and oxygen.

Hydrogen has flame temperature of approximately 4,000° F. and will generate about 300 psi of explosive force at a velocity exceeding 1,500 m/s. When the secondary explosion's blast wave meets the conversion load or a stepped up target load sequence, the dissociation and/or water-splitting process will continue until the load reservoir thermally buffers the temperature of the explosion's flame front to the extent that steam alone is generated and the reaction heat is consumed; whereas, the steam conversion process has been completed. At the point of achieving the preset pressure limit, the pressure-relief mechanism releases the steam to an energy recovery mechanism and the process recharges and repeats itself in another energy production cycle.

Xplogen's process can use either an explosive deflagration or a detonation to initiate the primary or driving explosion event. Most often when a detonation is achieved, it will occur as a result of an accelerating reaction, which undergoes a deflagration to detonation transition (DDT).

Xplogen's process balances the steam conversion load with the explosion's thermo-dynamic output thus preventing the loss of steam pressure by an excessive degree of thermal buffering from the conversion load reservoir/s. Likewise, Xplogen's process also prevents under-loading the conversion sequence and wasting energy not used for conversion purposes. See Table 2.0 for a graphical representation of this principle.

Xplogen's process uses target and conversion loads designed to optimize the performance of the steam conversion process. (Reference Table 2.0) If too little conversion load is placed within the path of the advancing blast wave, then the process wastes the thermo-dynamic potential of the explosion event episode. Conversely, if the blast wave meets too much conversion load resistance, then a premature quenching of the reaction will occur pursuant to the cooling effect presented by the excess reservoir loading; whereas, the dissociation process will not operate at its maximum efficiently and ultimately the quantity of steam generated will not be as great as that offered by a balanced loading scenario.

### Xplogen's Step-Up Water-Splitting Reaction Process

In Xplogen's Step-Up Water-Splitting Reaction Process additional intermediate steps (and/or reaction chambers) can be added to the base process allowing the first dissociation reaction to fuel the next larger dissociation reaction. In this manner, a limited quantity of fuel is added to start the sequence and the remaining reaction energy is drawn from the thermal decomposition of water and/or other hydrogen containing materials, which contribute dissociated hydrogen to fuel the perpetuation of the reaction. Figure M illustrates the basic principle of this process arrangement. Likewise in another configuration, the Xplogen process can be simplified a step by combining the intermediate dissociation step with the steam conversion step. (See Figure L for an illustration of this concept.)

This Step-Up, or phase up method, can be repeated to generate a significant amount of process energy output increase by inducing the process to self-fuel itself from the decomposition of water and/or other hydrogen containing substances.

### Xplogen System Performance Enhancements

Another means by which the performance of the Xplogen process is enhanced is by routing the system's intake of replacement fluids into the process system's cooling jackets to both cool the explosive reaction chamber as well as serve to preheat the fluid prior to injecting it into the system's target reservoirs. Accordingly, by raising the enthalpy, or temperature, of the fluid load reservoirs located with the Xplogen system, the efficiency of the dissociation and steam conversion reactions is increased.

Xplogen's process also allows other heat generation mechanisms to be employed to pre-heat the target load prior to injection and dissociation, thus increasing the enthalpy of the target substance and increasing the efficiency of the reaction. Temperatures of 2,500° K. are normally the maximum extent of process heating before the process material failure occurs and this has prevented other technologies from reaching the temperatures necessary for highly efficient dissociation. With the pre-heating step, Xplogen can boost the efficiency of the dissociation reaction by pulsing the target with a burst of extreme thermodynamic force and allow for the release of the dissociation energy and a period of process cool down before the next cycle occurs.

### Xplogen System Design

Another means by which the performance of the Xplogen process is enhanced is by routing explosively discharged gases into quenching fluids and using the resulting pressure and vacuum events as another source for the production of energy. The expanding and imploding gas release episode within the process fluid reservoirs also acts to:
1. Increase the amount of hydrogen produced by the rapid quenching effect;
2. Preserve the amount of hydrogen produced by the rapid quenching effect because hydrogen is only sparingly soluble in water;
3. Allow for a more rapid cooling of the gases as the micro bubble size created by the implosion episode creates a very high bubble heat transfer coefficient;
4. Allow condensation to occur at the bubble wall causing heat and foreign matter to leave the bubbles; and
5. Allow pollutant gases to be dissolved or absorbed into the fluid body for subsequent removal purposes.

### Environmental Advantages

Xplogen technology is an environmentally friendly process because of the unique manner in which the initiating reaction's flame front and the conversion loads interface within the system; whereas, in one or more embodiments of the present invention, process exhaust emissions are directly mixed with steam.

A slight positive induced charge is added to the field of process steam. The steam and exhaust mixture creates a highly efficient wet scrubber system and creates an atmosphere for dissolving gases into liquid as the steam pressure is routed through the energy conversion systems and ultimately becomes subject to condensation. Likewise, particulates are readily absorbed into the charged steam atmosphere and removed from the condensate at later stages in the process energy conversion process.

Both the Explo-Dynamics and Implo-Dynamics technologies are co-owned, co-pending invention applications, which compliment the present invention and also collectively offer a complete, environmentally advantageous energy production system for a variety of diverse fueling arrangements and operating scenarios.

In view of the preferred embodiments described above, it should be apparent to those skilled in the art that the present invention may be embodied in forms other than those specifically described herein without departing from the spirit or central characteristics of the invention. Thus, the specific embodiments described herein are to be considered as illustrative and by no means restrictive.

The above description is that of a preferred embodiment of the invention. Multiple modifications and variations are possible in light of the above teachings. It is therefore to be understood that, within the scope of the appended claims, the invention may be practiced otherwise than as specifically described. Any reference to claim elements in the singular, e.g. using the articles “a,” “an,” “the,” or “said” is not construed as limiting the element to the singular.

Further, it is to be understood that the present invention is not limited to the embodiments described above, but encompasses any and all embodiments within the scope of the preceding claims. None of the above inventions and patents, taken either singly or in combination, is seen to describe the instant invention as claimed.

The embodiments of the invention in which an exclusive property or privilege is claimed are defined as follows:

1. A method of generating energy from a series of process contained explosive and/or thermobaric reactions, wherein the energy generating system comprises one or more: ignition chamber mechanism for containing and controlling said reaction; a fuel injection mechanism; an air and/or oxidizer and/or gas injection mechanism, an ignition mechanism; an injection portal check valve mechanism; a blast outlet pressure-relief mechanism; a target chamber mechanism, a target dissociation load injection mechanism, a Reaction and/or Conversion chamber mechanism; a process control system; and one or more thermodynamic stimulation mechanisms for stimulating and transforming an explosion release episode to support a dissociation reaction with one or more embodiments being generally described in Figures: A, B, C, D, E, F, G, H, I, J, K, L, M, N, O, P, and Q.

2. The method of claim 1, wherein the fuel source for supporting said explosive reaction comprises a concentration of ignitable nano-particles and micro-particles and/or ignitable aerosol droplets and/or combustible gas and air and/or oxidizer, which is mixed and suspended in a turbulent airborne fuel cloud within said energy generating system for the purpose of propagating an explosion and/or thermobaric reaction of said fuel cloud.

3. The method of claim 1, wherein the ignition mechanism for initiating said explosive reaction comprises one or more of the following: an electrical spark; a laser pulse; a jet tube; the compression force of a piston; the compression force of an explosion shockwave; the compression force of a decreasing annular void; a converging explosion-induced air or gas jet; a chemical reaction; and/or residual heat from a previous explosion cycle.

4. The method of claim 1, wherein the Ignition Chamber mechanism, and/or the Target Chamber mechanism, and/or the Reaction and/or Conversion chamber mechanism, for containing and controlling said explosive reaction is comprised as a tubular, and/or cylindrical, and/or spherical metal chamber with one or more inlet and outlet portals and is comprised with one or more fixed or removable spherical, circular, or conical end cap structures for the purpose of reflecting, focusing, and intensifying said explosion shockwaves, turbulence, and adiabatic influence.

5. The method of claim 1, wherein the Ignition Chamber mechanism, and/or the Target Chamber mechanism, and/or the Reaction and/or Conversion chamber mechanism, is comprised with one or more coils of metal tube or bar placed circumferentially inside the Ignition Chamber for the purpose of inducing additional obstacle-based turbulence to an explosion reaction contained in, or passing through, said chamber/s and is further comprised with one or more internal annular orifice focusing rings for the like purpose of inducing additional obstacle-based turbulence to an explosion reaction contained in, or passing through, said chamber/s.

6. The method of claim 1, wherein the Ignition Chamber mechanism, and/or the Target Chamber mechanism, and/or the Reaction and/or Conversion chamber mechanism, is comprised with one or more parabolic focusing walls, internally positioned parabolic structures, and/or end cap structures whereupon the explosion's shockwave forces an adiabatic shock reflection episode to occur upon an imploding air/fuel pocket, which has been adiabatically forced into the confines of the parabolic structure and is thus overcome by the ensuing flame-front of the explosion's propagation, and influences an acceleration of the violence and turbulence of the explosion event as well as the amount of heat generated by the explosion episode by containing, concentrating, reflecting, and/or intensifying said explosive energy.

7. The method of claim 1, wherein one or more embodiments of said Ignition Chamber mechanism and/or the Reaction and/or Conversion chamber mechanism is comprised with one or more injection portals, whereas an applied pneumatic or mechanical force is used to thrust and propel an airborne concentration comprising one or more substances (including dust or suspended particles, air, oxygen, oxidizing substances, gas, vapor, and/or aerosol) through a pipe, hose, valve body, portal orifice, or other passageway into said Ignition Chamber, Target Chamber, Reaction Chamber and/or Conversion Chamber.

8. The method of claim 1, wherein one or more embodiments of said energy generating system's pressure relief and/or check valve mechanisms are comprised as being mechanically or automatically actuated via the process control system by an electrical, magnetic, pneumatic, hydraulic, or other such mechanically actuated artificial or natural means or mechanism to vent the fluid/gas pressures and thermal release episodes at the appropriate pressure moment in each process explosion cycle.

9. The method of claim 1, wherein one or more embodiments of said Ignition Chamber mechanism, and/or the Target Chamber mechanism, and/or the Reaction Chamber mechanism, is comprised with a pre-fire air and/or gas pressure load, which is applied to said chamber's interior atmosphere prior to igniting the airborne fuel-gas suspension cloud; wherein the adiabatic pressure potential of the ensuing explosion event is influenced by the addition of this step and the flame-front temperature and pressure release of the subsequent exothermic reaction is boosted by the adiabatic kinetics thus creating a greater degree of process pressure and/or heat output.

10. The method of claim 1, wherein one or more embodiments of said Ignition Chamber mechanism, and/or the Target Chamber mechanism, and/or the Reaction and/or Conversion Chamber mechanism, comprise a system for producing steam pressure by routing the thermodynamics release of said explosive reaction into a target substance body for the purpose of flash vaporizing a dissociation episode and directing the energy release into a conversion load for translation into steam pressure and one or more embodiments are generally described in Figures: D, G, I, J, K, L, M, O, and Q.

11. The method of claim 1, wherein one or more embodiments of said energy generating system comprises of a means to initiate a process contained explosion event series for inducing pressure wave episodes due to a rapid littoral reaction and associated steam generation event, which occurs when the explosive energy directly contacts a quantity of fluid and vaporizes said fluid into steam pressure; whereas said pressure wave episode is used to generate steam pressure or propel a working fluid for the purpose of producing torque and/or thrust for generating energy, momentum, or motive force and/or heat for an process application and one or more embodiments are generally described in Figures: D, E, G, I, J, K, L, M, O, and Q.

12. The method of claim 1, wherein one or more embodiments of said Ignition Chamber mechanism, and/or the Target Chamber mechanism, and/or the Reaction Chamber mechanism, for containing and controlling said explosive reaction comprises a process environment conducive to stimulating and controlling a deflagration to detonation (DDT) reaction for the purpose of magnifying the pressure and thermal output of a process contained explosion for energy production purposes.

13. The method of claim 1, wherein one or more embodiments of said energy generating system's process control mechanism is comprised by one or more components, which may include a microprocessor, programmable logic controller array, and/or computer system, which is used to support process control activities by monitoring fuel attributes, flows, inventories and thus triggering the transfer and ignition of said fuel in and through a series of multiple explosive reaction cycles whereupon the energy release is monitored and various process components are activated and deactivated according to a pre-programmed sequence with limits of operation as well as providing for the monitoring and control of the subsequent energy conversion operations managed therein.

14. The method of claim 1, wherein the energy generating system's process control system is comprised by one or more components, which includes one or more high-speed infrared pyrometer sensor units and portal mount window utilizing a sapphire, quartz, or other heat and pressure resistant lens components (and/or their functional equivalents) to allow for process temperature monitoring and control and is further comprised with one or more piezo-electric pressure transducer sensor components (and/or its functional equivalent), to allow for process pressure monitoring and control.

15. The method of claim 1, wherein one or more embodiments of the energy generating system is used as a heat source comprising a means of producing an enhanced thermal energy pulse for supporting a dissociation reaction for the thermolysis of a hydrogen containing fluid (such as water, hydrogen peroxide, ammonia) and/or the dissociation of a gas (such as methane and/or carbon dioxide) whereas the dissociation reaction is direct thermal or thermochemcial in nature.

16. The method of claim 1, wherein one or more embodiments of said energy generating system's process and/or process components is comprised with cooling mechanisms including water jacket arrangements, fluid sprays, heat exchangers, and/or radiators to provide for the continuous cooling of various process components.

17. A method according to claim 1 wherein said energy generating system or process system is comprised and constructed of one or more materials including steel, stainless steel, titanium, tungsten, chromium, nickel, tantalum, ceramic, and/or other metallic compounds identified in Groups 3 through 10 of the Periodic Table of Elements.

18. A method according to claim 1 whereas said energy production system comprises a means and method of supplying and/or supporting a steam reforming reaction, a water gas shift reaction, a carbon monoxide shift reaction, a synthesis or syngas reaction, a reverse Sabatier reaction, a reverse Bosch reaction, and/or a reverse synthesis dehydrogenation reaction.

19. The method of claim 1, wherein one or more embodiments of said energy generating system is used to support an energy generating reaction as a heat source and/or comprising a means of driving, supporting, or otherwise enhancing, one or more of the following processes or reactions:
a electrolysis generation of hydrogen gas from a fluid substance such as water and/or a fluidized mixture of solids (such as coal, methane hydrate, and/or biomass, etc);
b a magnetolysis reaction and/or magnetohydrodynamic, magnetofluiddynamic, and/or hydromagnetic reaction/s for the generation of heat and/or gas;
c a plasmolysis reaction, with or without a carbon dioxide catalyst; and/or
d a radiolysis reaction.

20. A system according to claim 1 wherein said energy production process is comprised of the following steps:
a) A contained process system is configured and provided to supply and support the energy conversion process (Figures: A, B, C, D, E, F, G, H, I, J, K, L, M, N, O, P, and Q);
b) An ignitable fuel (solid, gaseous, and/or liquid or any singular or combination mixture thereof) is injected into the first stage ignition chamber (Note: Figure K, Items: 4,5, & 6; and Figure N, Items: 1 & 2);
c) A quantity of air and/or another oxidizing substance is injected into the ignition chamber (Note: Figure K, Items: 4,5, & 6 (8*); and Figure N, Items: 1 & 2);
d) An ignition mechanism is triggered by the process control computer system to produce a spark or other ignition energy into the ignition chamber's internal atmosphere (Note: Figure K, Item 7; and Figure N, Item 5);
e) The fuel cloud is ignited and an explosive reaction is initiated within the confines of the ignition chamber (Note: Figure K, Item 1; and Figure N, Item 3);
f) The blast wave initiated within the confines of the ignition chamber is stimulated by internal obstructions and geometries designed to increase turbulence (Note: Figure K, Item I; and Figure N, Item 3);
g) The shock wave initiated within the confines of the ignition chamber is used to simulate a piston effect by creating an imploding annular shock wave compressing an air pocket ahead of the blast wave (Note: Figure K, Item I; and Figure N, Item 3);
h) The imploding air pocket is forced into one or more parabolic reflection structures within the reaction cylinder thereby creating an adiabatically enhanced thermal output effect as the blast wave overcomes this zone of stimulation and retreats in the path of least resistance (Note: Figure K, Item I; and Figure N, Item 3);
i) The intensified blast wave travels to and through a pressure relief mechanism (Note: Figure K, Item 10 & 11; and Figure N, Item 6);
j) The intensified blast wave travels to and through a confined target load chamber (Note: Figure K, Items 12 & 15; and Figure N, Item 7);
k) The stimulated thermal energy pulse causes a flash conversion the target load (and/or a target load combined with an inert gas such as argon) and excessive thermal forces within the ensuing blast wave dissociate the hydrogen and/or carbon dioxide and/or other gases contained within the target substance (Note: Figure K, Item 12; and Figure N, Item 7);
l) The dissociated gases (such as hydrogen, oxygen, carbon monoxide, and/or residual water vapor are propelled by the blast wave from the target chamber through a pressure relief mechanism into the reaction or conversion chamber (Note: Figure K, Items: 12, 15, 16, & 2; and Figure N, Items: 7, 10, & 12);
m) When the dissociated gases are released from a carbon-dioxide containing target load and the process intent is to produce hydrogen gas, the dissociated carbon monoxide is then released to a water shift reaction based sub-process where steam reforming or water gas shift reaction translates the carbon monoxide into hydrogen gas and carbon dioxide (Note: Figure M, Items:);
n) When the dissociated gases are released from hydrogen-containing target load (and/or a target load combined with an inert gas such as argon) and the process intent is to produce hydrogen, the heat from the ensuing blast wave is quenched in a liquid or gaseous quench mechanism and the dissociated and/or recombined hydrogen gas and other liberated gases are separated and removed in a gas separation and capture sub-process (Note: Figure M, Items:);
o) When the dissociated gases are released from hydrogen-containing target load and the process intent is to produce energy, the heat from the ensuing blast wave ignites the dissociated and/or recombined hydrogen gas and the liberated oxygen supports and enhances the thermal conversion of the secondary (or carry over) explosion, which results from the dissociation or water-splitting reaction (Note: Figure K, Items: 12, 15, 16, & 2; and Figure N, Items: 7, 10, & 12);
p) The secondary explosion is thermodynamically stimulated by the process configuration designed to increase turbulence and adiabatic influence (Note: Figure K, Item 2; and Figure N, Item 12);
q) The expanded gas release of the secondary explosion is routed into and through one or more secondary loads of fluid also within the confines of the process system (Note: Figure K, Items: 2, 17, & 22);
r) The stimulated advancing thermal energy pulse causes a littoral reaction, as it violently flash converts the secondary fluid load into steam pressure (Note: Figure K, Items: 12, 15, 16, & 2; and Figure N, Items: 7, 10, & 12);
s) The steam generated in the conversion of the secondary fluid or conversion load reservoir is driven into and through another pressure relief mechanism into a steam pressure reservoir (Note: Figure K, Items: 17, 22, 23, & 3; and Figure N, Items: 14 & 15);
t) The steam pressure generated is discharged into a turbine or other steam-to-energy mechanism for creating torque or thrust for providing motive force to a generator thus producing electricity or providing propulsion to a vehicle, watercraft, and/or process (Note: Figure K, Items: 17, 22, 23, & 3; and Figure N, Items: 14 & 15); and
u) As steam pressures are being relieved from the system's reservoir/s, fuel air/oxidizer, and target load re-charging is initiated so the next energy production cycle can be initiated (Note: Figure K, Items: 1, 4, 5, 6, 12, & 14; and Figure N, Items: 1, 2, 3, 7, & 8).

21. A method according to claim 1 whereas said energy production system comprises a means and method of dissociating environmentally detrimental greenhouse gas constituents (such as carbon dioxide) produced by the Fischer-Tropsch process, the Karrick process, the Bergius process, a Coal-To-Liquids (CTL) conversion process, a Gas-To-Liquids (GTL) conversion process, a Biomass-To-Liquids (BTL) conversion process, and/or another industrial, chemical, or petrochemical process.

22. A method according to claim 1 whereas in one or more embodiments of said energy production system, the method comprises a means of performing molecular dissociation at lower reaction temperatures due to thermochemical influence of an inorganic salt solution added to the dissociation target load substance and/or by passing process released gases through a catalytic chamber containing one or more metal oxide, zeolite, and/or nanometallic catalyst substances.

23. A method according to claim 1 whereas in one or more embodiments of said energy production system, the method comprises a means of using heat generated from one or more sources including fossil fueled combustion sources, electrical heat, solar reactor, nuclear reactor, for the purpose of preheating the target load substance prior to injecting said substance into the process system and inducing an explosion or thermobaric reaction driven dissociation reaction.

24. A method according to claim 1 whereas in one or more embodiments of said energy production system, the method comprises a means of quenching a dissociated quantity of gases to prevent their combustion using one or more of the following including water, steam, other fluid substances, argon and/or another inert gas.

25. A method according to claim 1 whereas in one or more embodiments of said energy production system, the method comprises a means of discharging a quantity of dissociated gases into a process contained body of fluid to quench the heat and induce the generation, and subsequent implosion of, steam pressure to increase the gas transfer efficiency, maximize the hydrogen recovery ratio, separate the pollutant solids and absorb or dissolve the pollutant gases, as well as causing a pressure and vacuum induced flow to said system fluids thereby creating a means for driving a turbine and producing energy.

26. A method according to claim 1 whereas in one or more embodiments of said energy production system, the method comprises a means of dissociating combustible gases and injecting those gases, or the active combusting products thereof, into an internal combustion engine, or an external combustion engine, for translation into usable energy.

27. The method of claim 1, wherein one or more embodiments of said energy generating system comprises a means of inducing an electrical current into the process system fluid zones and/or reservoirs subject to littoral reaction and/or steam expansion and implosion influence for the purpose of effecting an improved pollutant removal mechanism; whereby solid and gaseous contaminants are more efficiently transferred to the fluid medium of the process reservoir and are thus subject to treatment, recycling, capture, and/or gaseous sequestration activities.

28. The use of a thermobaric reaction or explosion to create a process contained thermal energy pulse for the purpose of supplying and supporting a dissociation reaction of a hydrogen containing substance leading to the direct of indirect generation of hydrogen and/or the energy recovery of the same.

29. A means of using a thermobaric reaction or explosion to create a process contained thermal energy pulse for the purpose of supplying and supporting a dissociation reaction of a hydrogen containing substance leading to the direct of indirect generation of hydrogen and/or the energy recovery of the same.
